(19) United States
(12) Patent Application Publication
(10) Pub. No.: US 2026/0111792 A1
(43) Pub. Date: Apr. 23, 2026

(54) SYSTEMS AND METHODS FOR PROMOTING DIVERSITY OF MACHINE LEARNING TRAINING DATA SETS THROUGH APPLICATION OF AN EMBEDDING FUNCTION

(71) Applicant: Shopify Inc., Ottawa (CA)

(72) Inventors: Neil Leonard Padgett, Toronto (CA); Ray Jayatunga, Toronto (CA); Thomas Lowe, Brooklyn, NY (US); Manish Chablani, Redmond, WA (US)

(21) Appl. No.: 18/984,210

(22) Filed: Dec. 17, 2024

Related U.S. Application Data
(60) Provisional application No. 63/710,244, filed on Oct. 22, 2024.
(60) Provisional application No. 63/716,520, filed on Nov. 5, 2024.

(51) Int. Cl. G06N 20/00; G06F 16/25

(52) U.S. Cl. CPC G06N 20/00; G06F 16/258

(57) ABSTRACT

In the field of machine learning, there may be challenges associated with constructing a comprehensive and diverse training data set. For example, the data that is available may not be sufficiently diverse, which may cause issues such as overfitting in a model trained using the available data. A computer-implemented method and system are provided to use an embedding function as a tool in assessing the diversity of a data set. The embedding function may be employed in constructing a training data set having a high degree of data diversity for training a model.

### CROSS-REFERENCE TO RELATED APPLICATION

The present application claims the benefit of U.S. Provisional Patent Application Ser. No. 63/716,520 filed on Nov. 5, 2024, and U.S. Provisional Patent Application Ser. No. 63/710,244 filed on Oct. 22, 2024, both of which are incorporated herein by reference in their entireties.

### FIELD

The present application relates to machine learning, and more particularly to training data sets for training machine learning models, and yet more particularly to using vector embeddings to construct training data sets having data diversity.

### BACKGROUND

In the field of machine learning, a data set may be used to train a machine learning model. For example, in what is known as supervised learning, data sets may include input data paired with corresponding labels or outcomes to guide a model's training. Unsupervised learning, on the other hand, is based on unlabeled data, relying on the model to discover hidden structures or groupings. As machine learning evolves, the demand for large, high-quality training data sets continues to grow, driving innovation in data collection and curation techniques.

### SUMMARY

In the field of machine learning, there may be challenges associated with constructing a comprehensive and diverse training data set. In some cases, the amount of available data that can be used as training data may be lacking due to there not being enough organically occurring data that is relevant to the desired application. Additionally, or alternatively, the data that is available may not be sufficiently diverse. Training a machine learning model using this data may therefore cause overfitting, leading to problems such as poor generalization and high variance.

In some other cases, there may be a large amount of available data samples. In such a case, it is still not guaranteed that the data is diverse. For example, the data could be highly redundant, with little diversity. However, even if there was diversity present within the data, using all of the data samples to train a machine learning model may be computationally intensive. For example, in complex models such as deep neural networks, each sample contributes to the computation of gradients and parameter updates. As such, adding more samples requires further updates, leading the system to take longer to complete a training epoch. Additionally, as the number of training samples grows, the time it takes to train the model also grows since the model has to process more information and iteratively adjust its parameters based on each sample. Moreover, after a certain number of training examples, there may be no significant improvement in the model's performance, if it all, particularly if portions of the data are redundant. In effect, there may be a saturation point where the model has effectively learned the underlying patterns in the data and providing additional training data points does not provide new information that improves the performance. Thus, if the dataset contains samples that are highly similar, including more data from it in the training set derived from it may have the effect of increasing training time while having no significant improvements to model performance and/or simply increasing the computing resources consumed in the training process.

Using a smaller training set rather than all available data may be employed for a variety of reasons such as may be known to persons skilled in the art of machine learning. For example, it may be that some of the larger data set may be held back for use in model validation. Additionally or alternatively, it may be that there are concerns about bias from a lack of diversity in the larger data set and the construction of a more diverse training set by subsetting the larger data set may be employed in an effort to avoid or limit the transfer of this bias to the trained model. Additionally or alternatively, the larger data set may be particularly large and it may be desired to create a subset thereof for use in training in order to reduce the overall computer processing required to train the model, with training processing being proportionate to the number of training examples used in training. Notably, even if such a reduction in processing may not be a goal, a reduction in the consumption of computing resources may nonetheless generally be provided when a smaller training set is employed as opposed to a larger one.

Conventional approaches to selecting training data from a data pool may involve using random selection. Using random selection may not adequately address the diversity issue nor the redundancy issue. For example, if the initial data pool is inherently not diverse, implementing random selection to create a training data set will also fail to be diverse. If the initial data pool is sufficiently diverse but is also redundant, random sampling fails to guarantee that the resulting training data set will also be diverse. In some cases, the resulting data set may have some diversity, but may still suffer from redundancy. In such cases, training a machine learning model from the resulting data set still involves unnecessarily processing redundant data, and issues related to the training process being computationally intensive and long are not addressed.

Therefore, there exists a need for a system that can evaluate the diversity of a data set, as well as generate or modify a data set to be diverse while not redundant.

A vector embedding (alternatively referred to simply as an “embedding”) is an encoding of data into a dense vector representation such that more similar items are closer in a vector/embedding space. The computational function that produces an embedding may be referred to as an embedding function. The embedding function is typically a part of, or used within, an embedding model, which serves as the broader system for generating embeddings. The representation in the vector space typically takes the form of a real-valued vector. For example, a word embedding is a vector representation, usually real-valued, that encodes the meaning of a word in such a way that words that are closer in the vector space are expected to be similar in meaning. Word embeddings may be obtained, for example, using language modeling and feature learning techniques, where words or phrases from the vocabulary are mapped to vectors of real numbers that may encode both syntactic and semantic meaning. Popular methods for generating word embeddings include Word2Vec™, which uses shallow neural networks to predict word contexts or words given their context, and ELMo™ or BERT™, which generate context-sensitive embeddings through bidirectional language models, to account for different meanings of the same word in varying contexts. Developments in embedding techniques have significantly advanced natural language processing tasks, such as sentiment analysis, machine translation, and information retrieval, by providing a richer understanding of word meanings and relationships.

The inventors have recognized that an embedding function may be employed as a tool in assessing the diversity of a data set. The inventors have further recognized that this in turn may be employed in the construction of training data sets for machine learning models to control the diversity of those data sets. Put another way, it has been recognized by the inventors that use of an embedding function can be a proxy for measuring and controlling diversity in a training set. More particularly, employing an embedding function may allow construction of a training data set containing a high degree of data diversity. A training data set having a high degree of data diversity may allow training of a machine learning model with a smaller training data set without significantly impairing or reducing model performance as compared to if the training was done with a larger training data set. Using a larger training data set to train a model generally consumes more computing resources (e.g., CPU and memory) than training using a smaller training data set. Therefore, computing resources required for training the machine learning model may be reduced (because the training data set is smaller) while still achieving acceptable model performance because the training data set is more diverse.

In an aspect, an embedding function may be employed together with a generative AI model (e.g. a large language model (LLM)) in order to generate a synthetic training data set.

In another aspect, an embedding function may be employed in constructing a training data set based on an existing data set, with the embedding function used to control the diversity of data in the training data set. The training data set may be constructed as a subset of the larger existing data set and the embedding function may be used in the selection of what values to include in that subset.

In some implementations, there may be provided a computer-implemented method. The method may include receiving a set of data samples and generating a training data set for training a machine learning model based on the set of data samples. The generation may employ an embedding function for controlling a diversity of the training data set.

In some implementations, generating the training data set may include using the embedding function to convert at least some of the data samples into a set of embeddings, each embedding in the set of embeddings corresponding to a respective data sample in the set of data samples. Generating the training data set may further include determining proximity values using the set of embeddings. A proximity value may be indicative of proximity of an embedding to one or more other of the embeddings. Generating the training data set may further include selecting samples for the training data set based on the determined proximity values.

In some implementations, determining proximity values may include determining Euclidean distances between pairs of embeddings in the set of embeddings. In some implementations, determining proximity values may include determining cosine similarities between pairs of embeddings in the set of embeddings.

In some implementations, generating the training data set may include using the embedding function to convert at least some of the data samples into a set of embeddings, each embedding in the set of embeddings corresponding to a respective data sample in the set of data samples. Generating the training data set may further include determining a proximity value for each of one or more embeddings in the set of embeddings. A proximity value may be indicative of proximity of an embedding to one or more other of the embeddings. Generating the training data set may further include comparing each determined proximity value to a defined range. Generating the training data set may further include selecting a portion of embeddings based on the comparison, wherein each embedding included in the portion has a proximity value within the defined range. Generating the training data set may further include forming the training data set as the data samples that correspond to the selected portion of the set of embeddings.

In some implementations, determining the proximity value for an embedding in the set of embeddings may include computing a plurality of values, each value computed using the embedding and a respective different embedding by evaluating a distance metric or a similarity metric using the embedding and the respective different embedding. Determining the proximity value for an embedding in the set of embeddings may further include determining an average of the plurality of values, and determining the proximity value from the average of the plurality of values. In some implementations, the plurality of values may be a plurality of cosine similarity values, the similarity metric may be cosine similarity, and each cosine similarity value may be computed using the embedding and the respective different embedding by evaluating the cosine similarity of the embedding and the respective different embedding.

In some implementations, selecting the portion of embeddings may include assigning a ranking to each respective determined proximity value. Selecting the portion of embeddings may further include establishing the defined range based on the assigned rankings. Selecting the portion of embeddings may further include selecting the portion of embeddings whose respective rankings are within the defined range.

In some implementations, the set of data samples may be a first set of data samples, and generating the training data set may include inputting at least one of the first set of data samples into a generative model that utilizes machine learning to generate a second set of data samples. Generating the training data set may further include using the embedding function to convert at least some of the first set of data samples and at least some of the second set of data samples into a first set of embeddings and second set of embeddings. Each embedding in the first set of embeddings may correspond to a respective data sample in the first set of data samples and each embedding in the second set of embeddings may correspond to a respective data sample in the second set of data samples. For each of one or more embeddings in the second set of embeddings, generating the training data set may further include determining a proximity value using at least one embedding from the first set of embeddings, where a proximity value may be indicative of proximity of an embedding to one or more other of the embeddings, comparing the proximity value to a defined range, and if the proximity value is within the defined range, selecting the respective data sample in the second set of data sample corresponding to the embedding to be included in the training data set.

In some implementations, determining the proximity value for an embedding in the second set of embeddings may include evaluating a distance metric or a similarity metric using the embedding and an embedding from the first set of embeddings. In some implementations, the distance metric may be Euclidean distance, and determining the proximity value may include evaluating the Euclidean distance between the embedding and an embedding from the first set of embeddings.

In some implementations, the training data set may further include the first set of data samples.

In some implementations, generating the training data set may include inputting the first set of data samples into a generative model that utilizes machine learning to generate a second set of data samples. Generating the training data set may further include using the embedding function to convert at least some of the first set of data samples and at least some of the second set of data sample into a first set of embeddings and a second set of embeddings. Each embedding in the first set of embeddings may correspond to a respective data sample in the first set of data samples and each embedding in the second set of embeddings may correspond to a respective data sample in the second set of data samples. Generating the training data set may further include determining a proximity value for each embedding in the first set of embeddings and the second set of embeddings, where the proximity value may be indicative of proximity of an embedding to one or more other of the embeddings. Generating the training data set may further include selecting a portion of embeddings from the first and second sets of embeddings, where each embedding included in the portion of embeddings may have a proximity value within a defined range. Generating the training data set may further include forming the training data set as the data samples that correspond to the selected portion of embeddings.

In some implementations, there may be provided a computer-implemented method. The method may include obtaining a plurality of data samples and generating a training data set based on the plurality of data samples. The generation of the training data set may employ an embedding function in/for controlling the diversity of the generated training data set.

In some implementations, the plurality of data samples may be example training elements, and the method may further include providing at least some of the example training elements to a large language model (LLM). Synthetic training data generated by the LLM based on the aforementioned some (or all) of the example training elements may be received from the LLM. The training data set may be based on the synthetic training data generated by the LLM. The diversity of the training data set may be controlled based on application of the embedding function to the synthetic training data and on comparing embeddings of elements of the synthetic training data to embeddings of other elements of the synthetic training data and/or embeddings of the example training elements.

In some implementations, the plurality of data samples may form a large data set, and generating the training data set based on the plurality of data samples may include selecting a subset of the large data set as the training data set. That subset may be identified based on comparisons of embeddings of data samples of the large data set. It may be that the generating of the training data set employs an iterative process in selecting the subset of the large data set as the training set. Such an iterative process may include comparing embeddings at each iteration of the iterative process.

In some implementations, the plurality of data samples may form or be an original training data set. It may be that generating the training data set based on the plurality of data samples includes assessing the diversity of the original training data set using an embedding function. Such assessing may include using the embedding function to identify data points of the original training data set representative of underrepresented classes of data. Additional data points that are similar to the identified data points (i.e., the data points representative of underrepresented classes of data) may be obtained. The original training data set may be augmented with the additional data points. This augmenting may then yield the training data set. In some such implementations, similarity of the additional data points to the identified data points may be assessed using the embedding function.

In some implementations, the embedding function employed may be selected from amongst Word2Vec, GloVe, and BERT.

In some implementations, the method may further include training a machine learning model using the generated training set.

In some implementations, there may be provided a computer system. The computer system may include a memory and at least one hardware processor. The memory may store instructions that, when executed by a hardware processor, cause the computer system to perform the above-discussed methods.

In some implementations, there may be provided a computer-readable medium. The computer-readable medium may be non-transitory. The computer-readable medium may store instructions that, when executed by a processor of a computer system, cause the computer system to perform the above-discussed methods.

In some implementations, there may be provided a computer program product. The computer program product may include instructions which, when the program is executed by a computer, cause the computer to carry out the above-discussed methods.

A system is also disclosed that is configured to perform the methods disclosed herein. For example, the system may include at least one processor and a memory storing processor-executable instructions that, when executed, cause the at least one processor to perform any of the methods disclosed herein.

In another aspect, there is provided a computer readable medium having stored thereon computer-executable instructions that, when executed by a computer, cause the computer to perform any of the methods disclosed herein. The computer readable medium may be non-transitory.

### BRIEF DESCRIPTION OF THE DRAWINGS

Implementations will be described, by way of example only, with reference to the accompanying figures wherein:

FIG. 1A is a simplified block diagram of an example simplified convolutional neural network;

FIG. 1B is a simplified block diagram of an example transformer neural network;

FIG. 2 is a block diagram of an example computing system;

FIG. 3 illustrates an example system for assessing and controlling diversity of data, according to some implementations;

FIG. 4 illustrates example processes of assessing and controlling diversity of data, according to some implementations;

FIG. 5 illustrates a vector database storing vector embeddings and various computed distance values based on the stored vector embeddings, according to some implementations;

FIG. 6 illustrates a representation of vector embeddings in a vector space, according to some implementations;

FIG. 7 illustrates an augmentation of underrepresented portions in a data set using vector embeddings, according to some implementations; and

FIG. 8 illustrates a method performed by a computing system, according to some implementations.

### DETAILED DESCRIPTION

For illustrative purposes, specific implementations will now be explained in greater detail below in conjunction with the figures.

To assist in understanding the present disclosure, some concepts relevant to neural networks and machine learning (ML) are first discussed.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which need not be discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), and multilayer perceptrons (MLPs), among others.

DNNs are often used as ML-based models for modeling complex behaviors (e.g., human language, image recognition, object classification, etc.) in order to improve accuracy of outputs (e.g., more accurate predictions) such as, for example, as compared with models with fewer layers. In the present disclosure, the term “ML-based model” or more simply “ML model” may be understood to refer to a DNN. Training a ML model refers to a process of learning the values of the parameters (or weights) of the neurons in the layers such that the ML model is able to model the target behavior to a desired degree of accuracy. Training typically requires the use of a training data set, which is a set of data that is relevant to the target behavior of the ML model. For example, to train a ML model that is intended to model human language (also referred to as a language model), the training data set may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. In another example, to train a ML model that is intended to classify images, the training data set may be a collection of images. Training data may be annotated with ground truth labels (e.g. each data entry in the training data set may be paired with a label), or may be unlabeled.

Training a ML model generally involves inputting into an ML model (e.g. an untrained ML model) training data to be processed by the ML model, processing the training data using the ML model, collecting the output generated by the ML model (e.g. based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or may be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training a ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of a ML model typically involves further training the ML model on a number of data samples (which may be smaller in number/cardinality than those used to train the model initially) that closely target the specific task. For example, a ML model for generating natural language that has been trained generically on publicly-available text corpuses may be, e.g., fine-tuned by further training using the complete works of Shakespeare as training data samples (e.g., where the intended use of the ML model is generating a scene of a play or other textual content in the style of Shakespeare).

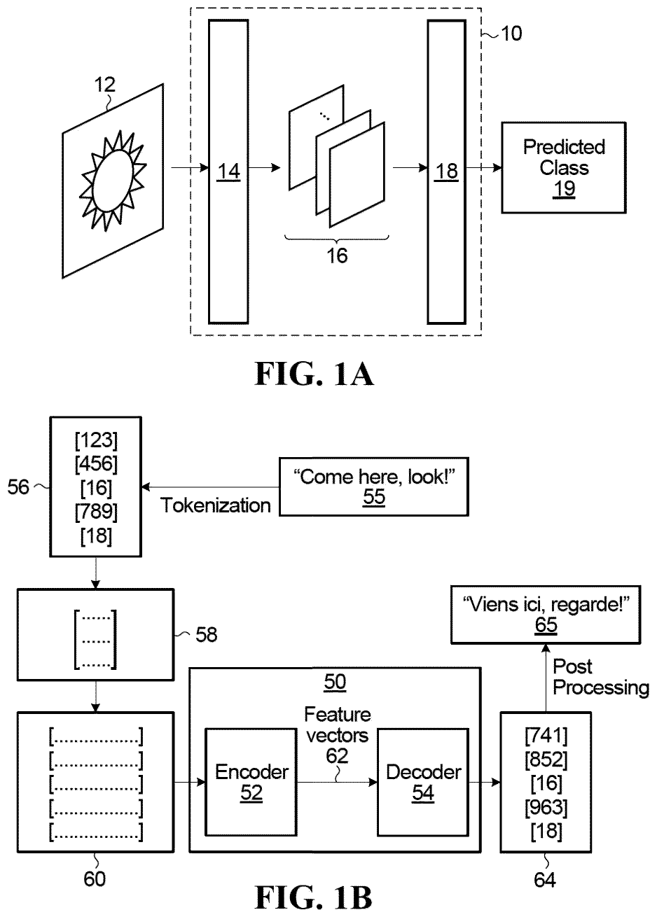

FIG. 1A is a simplified diagram of an example CNN 10, which is an example of a DNN that is commonly used for image processing tasks such as image classification, image analysis, object segmentation, etc. An input to the CNN 10 may be a 2D RGB image 12.

The CNN 10 includes a plurality of layers that process the image 12 in order to generate an output, such as a predicted classification or predicted label for the image 12. For simplicity, only a few layers of the CNN 10 are illustrated including at least one convolutional layer 14. The convolutional layer 14 performs convolution processing, which may involve computing a dot product between the input to the convolutional layer 14 and a convolution kernel. A convolutional kernel is typically a 2D matrix of learned parameters that is applied to the input in order to extract image features. Different convolutional kernels may be applied to extract different image information, such as shape information, color information, etc.

The output of the convolution layer 14 is a set of feature maps 16 (sometimes referred to as activation maps). Each feature map 16 generally has smaller width and height than the image 12. The set of feature maps 16 encode image features that may be processed by subsequent layers of the CNN 10, depending on the design and intended task for the CNN 10. In this example, a fully connected layer 18 processes the set of feature maps 16 in order to perform a classification of the image, based on the features encoded in the set of feature maps 16. The fully connected layer 18 contains learned parameters that, when applied to the set of feature maps 16, outputs a set of probabilities representing the likelihood that the image 12 belongs to each of a defined set of possible classes. The class having the highest probability may then be outputted as the predicted classification for the image 12.

In general, a CNN may have different numbers and different types of layers, such as multiple convolution layers, max-pooling layers and/or a fully connected layer, among others. The parameters of the CNN may be learned through training, using data having ground truth labels specific to the desired task (e.g., class labels if the CNN is being trained for a classification task, pixel masks if the CNN is being trained for a segmentation task, text annotations if the CNN is being trained for a captioning task, etc.), as discussed above.

Some concepts in ML-based language models are now discussed. It may be noted that, while the term “language model” has been commonly used to refer to a ML-based language model, there could exist non-ML language models. In the present disclosure, the term “language model” may be used as shorthand for ML-based language model (i.e., a language model that is implemented using a neural network or other ML architecture), unless stated otherwise. For example, unless stated otherwise, “language model” encompasses LLMs.

A language model may use a neural network (typically a DNN) to perform natural language processing (NLP) tasks such as language translation, image captioning, grammatical error correction, and language generation, among others. A language model may be trained to model how words relate to each other in a textual sequence, based on probabilities. A language model may contain hundreds of thousands of learned parameters or in the case of a large language model (LLM) may contain millions or billions of learned parameters or more.

In recent years, there has been interest in a type of neural network architecture, referred to as a transformer, for use as language models. For example, the Bidirectional Encoder Representations from Transformers (BERT) model, the Transformer-XL model and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

FIG. 1B is a simplified diagram of an example transformer 50, and a simplified discussion of its operation is now provided. The transformer 50 includes an encoder 52 (which may comprise one or more encoder layers/blocks connected in series) and a decoder 54 (which may comprise one or more decoder layers/blocks connected in series). Generally, the encoder 52 and the decoder 54 each include a plurality of neural network layers, at least one of which may be a self-attention layer. The parameters of the neural network layers may be referred to as the parameters of the language model.

The transformer 50 may be trained on a text corpus that is labelled (e.g., annotated to indicate verbs, nouns, etc.) or unlabelled. LLMs may be trained on a large unlabelled corpus. Some LLMs may be trained on a large multi-language, multi-domain corpus, to enable the model to be versatile at a variety of language-based tasks such as generative tasks (e.g., generating human-like natural language responses to natural language input).

An example of how the transformer 50 may process textual input data is now described. Input to a language model (whether transformer-based or otherwise) typically is in the form of natural language as may be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph, etc.) into a sequence of shorter segments that are converted to numerical representations referred to as tokens (or “compute tokens”). Typically, a token may be an integer that corresponds to the index of a text segment (e.g., a word) in a vocabulary data set. Often, the vocabulary data set is arranged by frequency of use. Commonly occurring text, such as punctuation, may have a lower vocabulary index in the data set and thus be represented by a token having a smaller integer value than less commonly occurring text. Tokens frequently correspond to words, with or without whitespace appended. In some examples, a token may correspond to a portion of a word. For example, the word “lower” may be represented by a token for [low] and a second token for [er]. In another example, the text sequence “Come here, look!” may be parsed into the segments [Come], [here], [,], [look] and [!], each of which may be represented by a respective numerical token. In addition to tokens that are parsed from the textual sequence (e.g., tokens that correspond to words and punctuation), there may also be special tokens to encode non-textual information. For example, a [CLASS] token may be a special token that corresponds to a classification of the textual sequence (e.g., may classify the textual sequence as a poem, a list, a paragraph, etc.), a [EOT] token may be another special token that indicates the end of the textual sequence, other tokens may provide formatting information, etc.

In FIG. 1B, a short sequence of tokens 56 corresponding to the text sequence “Come here, look!” is illustrated as input to the transformer 50. Tokenization of the text sequence into the tokens 56 may be performed by some pre-processing tokenization module such as, for example, a byte pair encoding tokenizer (the “pre” referring to the tokenization occurring prior to the processing of the tokenized input by the LLM), which is not shown in FIG. 1B for simplicity. In general, the token sequence that is inputted to the transformer 50 may be of any length up to a maximum length defined based on the dimensions of the transformer 50 (e.g., such a limit may be 2048 tokens in some LLMs). Each token 56 in the token sequence is converted into an embedding vector 60 (also referred to simply as an embedding). An embedding 60 is a learned numerical representation (such as, for example, a vector) of a token that captures some semantic meaning of the text segment represented by the token 56. The embedding 60 represents the text segment corresponding to the token 56 in a way such that embeddings corresponding to semantically-related text are closer to each other in a vector space than embeddings corresponding to semantically-unrelated text. For example, assuming that the words “look”, “see”, and “cake” each correspond to, respectively, a “look” token, a “see” token, and a “cake” token when tokenized, the embedding 60 corresponding to the “look” token will be closer to another embedding corresponding to the “see” token in the vector space, as compared to the distance between the embedding 60 corresponding to the “look” token and another embedding corresponding to the “cake” token. The vector space may be defined by the dimensions and values of the embedding vectors. Various techniques may be used to convert a token 56 to an embedding 60. For example, another trained ML model may be used to convert the token 56 into an embedding 60. In particular, another trained ML model may be used to convert the token 56 into an embedding 60 in a way that encodes additional information into the embedding 60 (e.g., a trained ML model may encode positional information about the position of the token 56 in the text sequence into the embedding 60). In some examples, the numerical value of the token 56 may be used to look up the corresponding embedding in an embedding matrix 58 (which may be learned during training of the transformer 50).

The generated embeddings 60 are input into the encoder 52. The encoder 52 serves to encode the embeddings 60 into feature vectors 62 that represent the latent features of the embeddings 60. The encoder 52 may encode positional information (i.e., information about the sequence of the input) in the feature vectors 62. The feature vectors 62 may have very high dimensionality (e.g., on the order of thousands or tens of thousands), with each element in a feature vector 62 corresponding to a respective feature. The numerical weight of each element in a feature vector 62 represents the importance of the corresponding feature. The space of all possible feature vectors 62 that can be generated by the encoder 52 may be referred to as the latent space or feature space.

Conceptually, the decoder 54 is designed to map the features represented by the feature vectors 62 into meaningful output, which may depend on the task that was assigned to the transformer 50. For example, if the transformer 50 is used for a translation task, the decoder 54 may map the feature vectors 62 into text output in a target language different from the language of the original tokens 56. Generally, in a generative language model, the decoder 54 serves to decode the feature vectors 62 into a sequence of tokens. The decoder 54 may generate output tokens 64 one by one. Each output token 64 may be fed back as input to the decoder 54 in order to generate the next output token 64. By feeding back the generated output and applying self-attention, the decoder 54 is able to generate a sequence of output tokens 64 that has sequential meaning (e.g., the resulting output text sequence is understandable as a sentence and obeys grammatical rules). The decoder 54 may generate output tokens 64 until a special [EOT] token (indicating the end of the text) is generated. The resulting sequence of output tokens 64 may then be converted to a text sequence in post-processing. For example, each output token 64 may be an integer number that corresponds to a vocabulary index. By looking up the text segment using the vocabulary index, the text segment corresponding to each output token 64 can be retrieved, the text segments can be concatenated together and the final output text sequence (in this example, “Viens ici, regarde!”) can be obtained.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that may be considered to be an encoder-only language model. A decoder-only language model accepts embeddings as input and may use auto-regression to generate an output text sequence. Transformer-XL and GPT-type models may be language models that are considered to be decoder-only language models.

Because GPT-type language models tend to have a large number of parameters, these language models may be considered LLMs. An example GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2048 input tokens), and is able to generate a large number of tokens as output (e.g., up to 2048 tokens). GPT-3 has been trained as a generative model, meaning that it can process input text sequences to predictively generate a meaningful output text sequence. ChatGPT is built on top of a GPT-type LLM, and has been fine-tuned with training data sets based on text-based chats (e.g., chatbot conversations). ChatGPT is designed for processing natural language, receiving chat-like inputs and generating chat-like outputs.

A computing system may access a remote language model (e.g., a cloud-based language model), such as ChatGPT or GPT-3, via a software interface (e.g., an application programming interface (API)). Additionally or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM may be referred to as a prompt, which is a natural language input that includes instructions to the LLM to generate a desired output. A computing system may generate a prompt that is provided as input to the LLM via its API. As described above, the prompt may optionally be processed or pre-processed into a token sequence prior to being provided as input to the LLM via its API. A prompt can include one or more examples of the desired output, which provides the LLM with additional information to enable the LLM to better generate output according to the desired output. Additionally or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

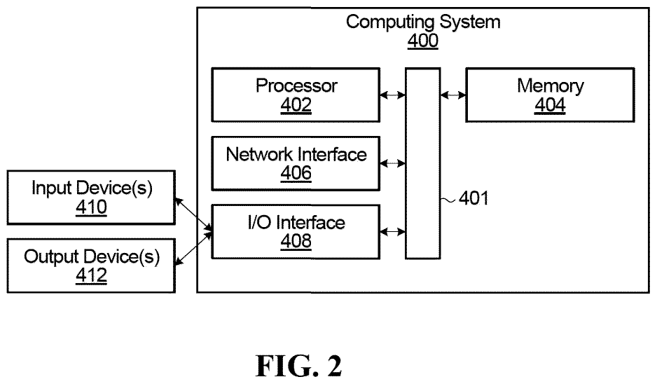

FIG. 2 illustrates an example computing system 400, which may be used to implement examples of the present disclosure, such as a prompt generation engine to generate prompts to be provided as input to a language model such as an LLM. Additionally or alternatively, one or more instances of the example computing system 400 may be employed to execute the LLM. For example, a plurality of instances of the example computing system 400 may cooperate to provide output using an LLM in manners as discussed above.

The example computing system 400 includes at least one processing unit, such as a processor 402, and at least one physical memory 404. The processor 402 may be, for example, a central processing unit, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. The memory 404 may include a volatile or non-volatile memory (e.g., a flash memory, a random access memory (RAM), and/or a read-only memory (ROM)). The memory 404 may store instructions for execution by the processor 402, to the computing system 400 to carry out examples of the methods, functionalities, systems and modules disclosed herein.

The computing system 400 may also include at least one network interface 406 for wired and/or wireless communications with an external system and/or network (e.g., an intranet, the Internet, a P2P network, a WAN and/or a LAN). A network interface may enable the computing system 400 to carry out communications (e.g., wireless communications) with systems external to the computing system 400, such as a language model residing on a remote system.

The computing system 400 may optionally include at least one input/output (I/O) interface 408, which may interface with optional input device(s) 410 and/or optional output device(s) 412. Input device(s) 410 may include, for example, buttons, a microphone, a touchscreen, a keyboard, etc. Output device(s) 412 may include, for example, a display, a speaker, etc. In this example, optional input device(s) 410 and optional output device(s) 412 are shown external to the computing system 400. In other examples, one or more of the input device(s) 410 and/or output device(s) 412 may be an internal component of the computing system 400.

A computing system, such as the computing system 400 of FIG. 2, may access a remote system (e.g., a cloud-based system) to communicate with a remote language model or LLM hosted on the remote system such as, for example, using an application programming interface (API) call. The API call may include an API key to enable the computing system to be identified by the remote system. The API call may also include an identification of the language model or LLM to be accessed and/or parameters for adjusting outputs generated by the language model or LLM, such as, for example, one or more of a temperature parameter (which may control the amount of randomness or “creativity” of the generated output) (and/or, more generally some form of random seed as serves to introduce variability or variety into the output of the LLM), a minimum length of the output (e.g., a minimum of 10 tokens) and/or a maximum length of the output (e.g., a maximum of 1000 tokens), a frequency penalty parameter (e.g., a parameter which may lower the likelihood of subsequently outputting a word based on the number of times that word has already been output), a “best of” parameter (e.g., a parameter to control the number of times the model will use to generate output after being instructed to, e.g., produce several outputs based on slightly varied inputs). The prompt generated by the computing system is provided to the language model or LLM and the output (e.g., token sequence) generated by the language model or LLM is communicated back to the computing system. In other examples, the prompt may be provided directly to the language model or LLM without requiring an API call. For example, the prompt could be sent to a remote LLM via a network such as, for example, as or in message (e.g., in a payload of a message).

A training data set may be data used to train a machine learning model. Training data sets are a foundation of machine learning models, providing a model with examples needed to teach the model how to make predictions or decisions as desired. However, there may be challenges associated with constructing a training data set that can lead to a well-performing machine-learning model. As discussed above, one challenge may be that a training data set may not be formed from data samples that are sufficiently diverse. This may cause a model trained using the data set to have problems such as overfitting, poor generalization, and high variance. Another challenge may be that in some cases, there may not be enough organically occurring data relevant to the desired application resulting in a small training data set. This may lead to a model that has issues such as poor generalization and difficulty in capturing necessary patterns within the data. For example, the small data set may fail to provide enough examples of complex or subtle relationships within the data, leading to a model that relies on simplistic rules and fails to capture nuanced patterns critical for the model to perform accurately. Still another challenge may be that in some cases, there may be a vast amount of available data. In such a case, it is still not guaranteed that the data pool is diverse. However, even if there was diversity present within the data, using all of the available data to train a model may be computationally intensive. Conventional approaches to selecting training data from such a vast data pool may involve using random selection, which cannot guarantee that any diversity of the original data pool is maintained. Of course, if the original data, though vast, was not diverse, the resulting training data will also fail to be diverse (i.e., these conventional approaches may not be able to introduce diversity that is not present in the first place).

Therefore, there exists a need for a system that can evaluate the diversity of a data set, as well as generate or modify a data set in a manner that ensures the resulting data set captures the diversity of examples a model may encounter in deployment.

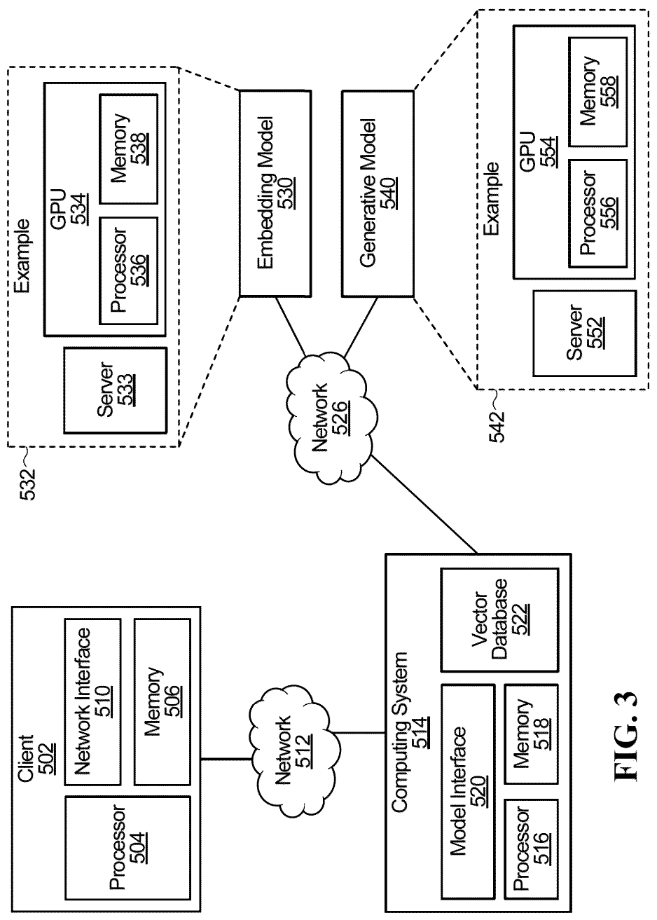

FIG. 3 illustrates a system for assessing and controlling diversity of data, according to some implementations. The system of FIG. 3 can be used to assess the diversity of a data set, and construct a training data set for use in training a machine learning model, based on the original data set, that is more diverse.

The system includes a client 502, which may, in some instances, be a user device. Only one client is illustrated, but the system may include multiple clients, e.g., all accessing a computing system 514 in parallel. The client 502 may be a system that includes or receives data to be assessed using the computing system 514 and communicates with the computing system 514. For example, the client 502 may be a user device or the client 502 may be a server. If the client 502 is a user device, it may be a personal computer, or laptop, or desktop computer, or mobile device such as a tablet or smartphone, or an augmented reality (AR) device, etc., depending upon the implementation. The client 502 includes a processor 504, memory 506, and network interface 510. The processor 504 controls the operations of the client 502, and may be implemented by one or more processors that execute instructions stored in the memory 506. Alternatively, some or all of the processor 504 may be implemented using dedicated circuitry, such as an application specific integrated circuit (ASIC), a graphics processing unit (GPU), or a programmed field programmable gate array (FPGA). The memory 506 stores information (e.g. content and/or instructions, etc.). If the client 502 is a user device, a user interface (not shown) may be included which allows a user (e.g., a human) to provide input to and receive output from the user device. For example, the user interface may include a display (which may be a touch screen), and/or a keyboard, and/or a mouse, etc. The network interface 510 interfaces with a network 512 to perform communication (transmit/receive) over that network 512. The structure of the network interface 510 will depend on how the client 502 interfaces with the network 512. For example, if the client 502 is a user device such as a smartphone or tablet, the network interface 510 may comprise a transmitter/receiver with an antenna to send and receive wireless transmissions over the network 512, and if the client 502 is a user device such as a personal computer connected to the network 512 with a network cable, the network interface 510 may comprise a network interface card (NIC), and/or a computer port (e.g. a physical outlet to which a plug or cable connects), and/or a network socket, etc. If the client 502 is a server, the server may store and/or receive input data from other systems or devices for transmission over the network 512 and may receive output data over the network 512.

The system of FIG. 3 further includes a computing system 514. The computing system 514 includes a processor 516, memory 518, and a model interface 520 that is used to access one or more embedding models and/or one or more generative models. The processor 516 controls the operations of the computing system 514. The processor 516 may be implemented by one or more processors that execute instructions stored in the memory 518. Alternatively, some or all of the processor 516 may be implemented using dedicated circuitry, such as an ASIC, GPU, or FPGA. The memory 518 stores information (e.g. content and/or instructions, etc.). The model interface 520 interfaces with an embedding model or a generative model, e.g., by sending input data over a network 526 and receiving output data generated by the embedding model or generative model back over the network 526. For example, input data sent over the network 526 to a generative model may include one or more prompts or a processed/pre-processed version thereof, and input data sent over the network 526 to an embedding model may include text, images, audio, structured data, etc., or a processed/pre-processed version thereof. The model interface 520 may be or include an API key to enable the computing system 514 to be identified by the system hosting the embedding model or generative model. The API call may include an identification of the embedding model or generative model to be accessed. The API call may include one or more configuration settings that adjust the output generated by the embedding model or generative model to be accessed. In some implementations, the model interface 520 may actually comprise a plurality of different interfaces, e.g. a different API for each embedding model and generative model, where one API is used to send prompts and configuration settings to a first embedding or generative model and receive responses from that first embedding or generative model, and where a different API is used to send prompts and configuration settings to a second embedding or generative model and receive responses from that second embedding or generative model. In an alternative embodiment, the model interface 520 may comprise a single API that can interface with multiple generative models, e.g. if the multiple generative models are the same (e.g. different instances of the same model accessible via different endpoints). In some implementations, the model interface 520 need not be or include an API, e.g. it may communicate with a generative model and/or embedding model via messages sent to/received from the generative model and/or embedding model without use of an API, e.g. network messages sent over the Internet. The model interface 520 may be implemented by the processor 516, e.g. by the processor 516 executing instructions that cause the processor 516 to perform the functions of the generative model interface 520.

The computing system 514 further includes a vector database 522. The vector database 522 may store vector embeddings produced by one or more embedding models, as discussed hereinafter.

Although not illustrated, the computing system 514 also includes one or more network interfaces for communicating over network 512 and network 526. A network interface may comprise a network interface card (NIC), and/or a computer port (e.g. a physical outlet to which a plug or cable connects), and/or a network socket, etc. The model interface 520 might be considered part of the network interface that interfaces with network 526, depending upon the implementation.

The system of FIG. 3 further includes an embedding model 530 and a generative model 540, both accessible to the computing system 514 over network 526. For example, the network 526 may be the Internet, the embedding model 530 may be at a first endpoint accessible via the Internet, and the generative model 540 may be at a second endpoint accessible via the Internet. Although one embedding model 530 and one generative model 540 is illustrated, the system of FIG. 3 may include multiple embedding models and/or multiple generative models.

Stippled box 532 shows an example of how the embedding model 530 may be implemented. The embedding model 530 may be executed by a specialized processing unit, e.g. one designed to accelerate computer operations of an embedding model through parallelization of operations, which may allow for faster execution of the embedding model 530 compared to a more general-purpose processing unit. For example, the specialized processing unit may be a GPU or a tensor processing unit (TPU) or a neural processing unit (NPU) or a hardware accelerator. In the example in stippled box 532, there is a specialized processing unit in the form of GPU 534 that includes one or more processing circuits (illustrated as processor 536) and memory 538. The code and parameters of the embedding model 532 are stored in the memory 538 and executed by the processor 536. The specialized processing unit may be paired with a general-purpose processing unit, e.g. a computer, central processing unit (CPU), and/or other computing device such as a server. The general-purpose processing unit may handle and/or prioritize requests originating from different clients, provide data to be embedded to the model, receive embeddings and provide those embeddings to the clients. For example, the general-purpose processing unit may receive an API call from the model interface 520, as well as from other systems wanting to access the embedding model 530, and provide API responses. In the example in stippled box 532, the general-purpose processing unit is in the form of a server 533. The structure illustrated in stippled box 532 is just an example. Alternative implementations are possible. For example, in an alternative implementation the embedding model 530 may be executed on a single computing device, e.g. a powerful computer that both receives the API calls, prioritizes and handles requests, executes the model, and returns responses. In another alternative implementation, the embedding model 530 may be executed by a more general-purpose processing unit, such as a CPU.

Stippled box 542 shows an example of how the generative model 540 may be implemented. The generative model 540 may be executed by a specialized processing unit, e.g. one designed to accelerate computer operations of a generative model through parallelization of operations, which may allow for faster execution of the generative model 540 compared to a more general-purpose processing unit. For example, the specialized processing unit may be a GPU or a tensor processing unit (TPU) or a neural processing unit (NPU) or a hardware accelerator. In the example in stippled box 542, there is a specialized processing unit in the form of GPU 554 that includes one or more processing circuits (illustrated as processor 556) and memory 558. The code and parameters of the generative model 540 are stored in the memory 558 and executed by the processor 556. The specialized processing unit may be paired with a general-purpose processing unit, e.g. a computer, CPU, and/or other computing device such as a server. The general-purpose processing unit may handle and/or prioritize requests originating from different clients, provide prompts to the model, receive responses, and formulate and provide those responses to the clients. For example, the general-purpose processing unit may receive an API call from the model interface 520, as well as from other systems wanting to access the generative model, and provide API responses. In the example in stippled box 542 of FIG. 3, the general-purpose processing unit is in the form of a server 552. The structure illustrated in stippled box 542 is just an example. Alternative implementations are possible. For example, in an alternative implementation the generative model 540 may be executed on a single computing device, e.g. a powerful computer that both receives the API calls, prioritizes and handles requests, executes the model, and returns responses. Examples of the generative model 540 include BERT™, GPT-2™, GPT-3™, GPT-4™, CLIP™, and DALL-E™.

In some implementations, the embedding model 530 and the generative model 540 may each be provided by a software-as-a-service (SaaS) provider, possibly the same SaaS provider. In some implementations, the embedding model 530 and the second generative model 534 may be provided by different SasS providers, e.g. the embedding model 530 might be provided by BERT™ and the generative model 540 might be provided by Open AI™. In some implementations, one of the embedding model 530 and generative model 540 may be provided by a SaaS provider and the other one of the embedding model 530 and generative model 540 may be hosted locally.

In some implementations, the client 502 and the computing system 514 may be part of one system. For example, in a variation of FIG. 3 not illustrated, the computing system 514 may be one and the same as the client 502. In such implementations, the client 502 interfaces directly with the embedding model 530 and the generative model 540 over network 526. The vector database 522 may also be part of the client 502. Alternatively, the vector database 522 may be part of the embedding model 530 so that the embeddings are stored in the embedding model 530. It will be appreciated that in all scenarios described herein the operations performed by the computing system 514 could alternatively be performed by the client 502 in the absence of the separate computing system 514 and/or if the computing system 514 were considered part of or the same as the client 502, depending upon the implementation.

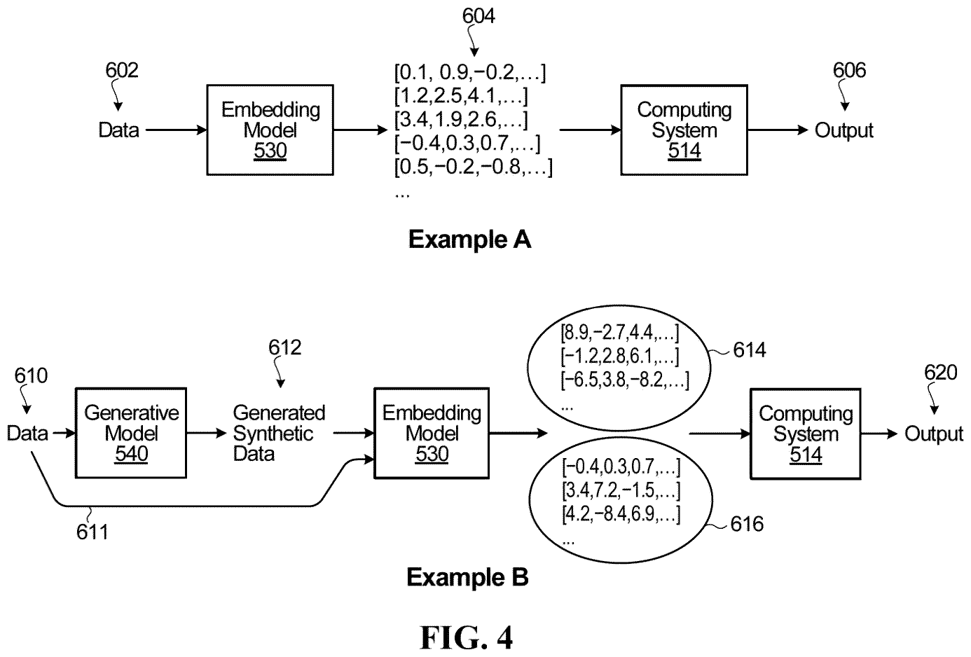

In operation, the client 502 may transmit data to the computing system 514 over the network 512. The computing system 514 may transmit the data, or at least a subset thereof, to the embedding model 530 over network 526. The data transmitted to the embedding model 530 may be referred to as an input data set. The embedding model 530 may perform some initial processing on the received input data set, e.g., tokenization as described above in relation to FIG. 1B, and utilize an embedding function to convert the pre-processed data into vector embeddings. In other words, the result of applying an embedding function to a data sample may be its “embedding”. The embedding model 530 may transmit the embeddings over network 526 to the computing system 514 where the embeddings are stored in the vector database 522. The computing system 514 may then perform computations based on the stored embeddings to assess the diversity of the input data set corresponding to the embeddings. This assessment of diversity can serve as the basis by which the computing system 514 can construct a training data set that is more diverse and/or less redundant as compared to the input data set. In some implementations, the generative model 540 may be used to generate synthetic data based on the data transmitted by the client 502 to the computing system 514. For example, the computing system 502 may transmit the data received from the client 502, or a portion thereof, over network 526 to the generative model 540. The transmitted data may be fed to the generative model 540 as part of a prompt, and the generative model 540 may generate synthetic data based on the transmitted data. The synthetic data generated by generative model 540 may then be transmitted over network 526 to the computing system 514 and may form part of the input data sent to the embedding model 530 to be converted to embeddings and analyzed by the computing system 514. These processes are described in more detail with reference to FIGS. 4-6.

FIG. 4 illustrates example processes of assessing and controlling diversity of data to ensure or promote diversity of a training data set, according to some implementations. With respect to data, a diverse data set may be defined as a data set having a variety of samples or data points that represent different characteristics or patterns. Ensuring diversity of a data set may mean selecting the data points making up the data set in such a way that the data set is representative, balanced, and contains a variety of examples to capture the full range of patterns, behaviors, or phenomena relevant to the task a machine learning model is to be trained for. Ensuring diversity while avoiding redundancy in a data set may mean selecting the data points making up the data set in such a way that avoids overrepresentation of certain subsets of data while still ensuring that meaningful subgroups, features, or scenarios are adequately represented in the data set.

In Example A of FIG. 4, input data 602 is transmitted by the computing system 514 to the embedding model 530 to be converted into embeddings. The input data 602 may be all of the data transmitted to the computing system 514 by client 502. Alternatively, in some implementations, the input data 602 may be a subset of the data transmitted by client 502. For example, where the data transmitted by client 502 is particularly large, the data may be reduced to some degree as a preprocessing step such as, e.g., by subsetting it (e.g., potentially prior to computing any embeddings). For example, conventional techniques for subsetting such as selecting a random subset may be employed. Where such subsetting is performed as an initial processing step, it may be that only the selected subset is transmitted by the computing system 514 to the embedding model 530 as input data 602. Notably, this may reduce the overall processing required for embedding as well as the amount of storage needed to store embedded data. The input data 602 may be formed of a set of data samples (which may alternatively be referred to as “data points”). For example, a data sample may correspond to a word, a sentence, an image, etc. The embedding model 530 may first tokenize the input data 602. Alternatively, a pre-processing tokenization module may be used to tokenize the input data and feed the tokenized data to the embedding model (not shown). The embedding model 530 converts the data samples of the input data 602 to embedding vectors 604. Each data sample of the input data 602 may correspond to one embedding. An embedding represents the data sample corresponding to one or more tokens in a way such that embeddings corresponding to semantically-related text are closer to each other in a vector space than embeddings corresponding to semantically-unrelated text. Examples of the embedding model 530 that may be used include Word2Vec™, GloVe™, BERT™, ResNet™, VGG™ (Visual Geometry Glove), and CLIP™. For example, for input data in the form of text, a transformer model such as BERT™ may leverage self-attention mechanisms to create embeddings that consider the context of each word in relation to all other words in a sentence. This means that the embedding for a word is influenced not just by its immediate neighbors, but by its entire context. If each data sample of the input data 602 is a sentence, for example, this means that the embedding corresponding to a sentence is influenced by the context of each of the words that form the sentence, allowing for a more nuanced understanding of meaning. Using a model such as BERT™, embedding vectors may be generated by processing the input data in both directions (left-to-right and right-to-left), which helps capture the intricacies of language, including polysemy and contextual dependencies. The conversion to embeddings enables the system to represent complex textual information in a format that is conducive to various machine learning tasks, such as clustering, classification, or retrieval.

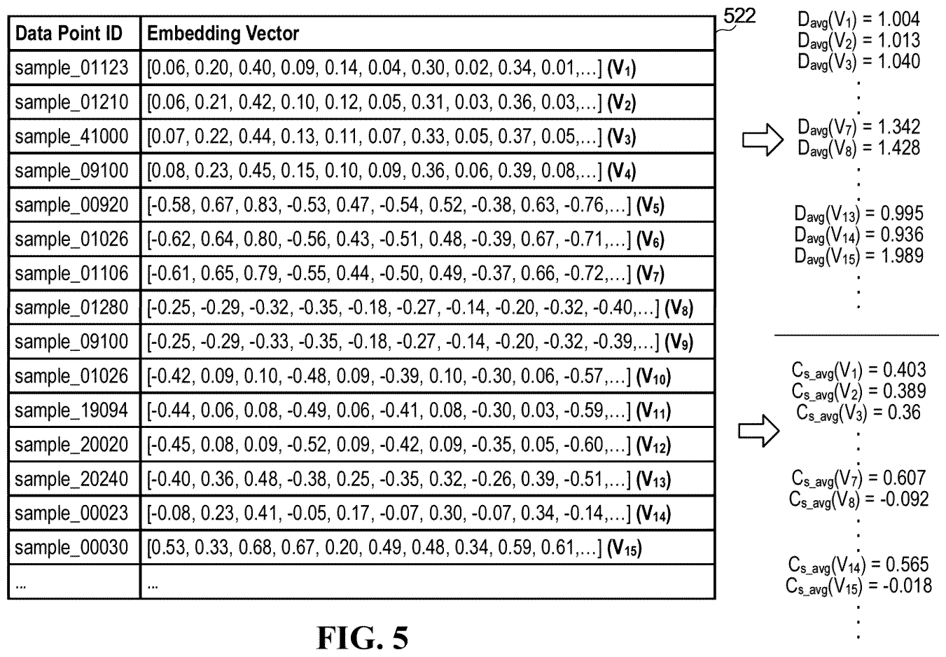

After the embedding model 530 converts the input data 602 into embedding vectors 604, the embedding model 530 transmits the embedding vectors 604 to the computing system 514. The computing system 514 may store the embedding vectors 604 in the vector database 522. Referring to FIG. 5, an example of the vector database or vector store 522 is shown. The vector database 522 may store the embeddings 604 in association with the data samples of the input data 602. For example, the data samples of input data 602 may be stored alongside the respective embeddings 604 thereof in the database 522 such as, for example, in a table and/or one or more tables such as may, for example, be linked by a key. As shown in FIG. 5, the vector database is illustrated as having one column which stores an ID associated with each data sample of the input data 602, and another column storing the embedding vector that corresponds to each respective data sample. The labelling of each vector as V₁, V2, . . . . V₁₅ in FIG. 5, is simply a notation included for ease of reference to each embedding vector, and such labels may not be actually included in the vector database 522. Although the vector database 522 is illustrated having two columns, this is just an example. In some implementations, there may be more columns storing other information or data. For example, if the data samples in the input data 602 are labelled as to their classes, the vector database 522 may have an additional column that stores information about the class corresponding to each data sample and embedding. In some implementations, the data samples of the input data 602 themselves, or some features associated with each of the data samples, may be stored and indexed in the database 522. For example, the database 522 may be indexed/have one or more indexes.

Referring back to Example A of FIG. 4, the computing system 514 may then perform calculations and determinations based on the embeddings to produce an output 606. The output 606 may, in some implementations, be a subset of the data sample that formed input 602.

To arrive at the output 606, the computing system 514 may calculate proximity values based on the embeddings to determine one or more measures of diversity for the input data 602. For example, an overall diversity of the input data 602, or the diversity of a certain portion of the input data 602, may be determined using the proximity values. A proximity value may be defined as a value indicative of how close or nearby (i.e. how proximate) embeddings may be to each other. It is indicative of proximity of an embedding to one or more other embeddings, and may be thus indicative of similarity of an embedding to one or more other embeddings.

In some implementations, calculating proximity values by the computing system 514 may include use of Euclidean distance values or cosine similarity values. For example, Euclidean distance may be calculated using a distance metric, a function for measuring the distance between two points in a space, such as the distance between two embedding vectors in a vector space. Cosine similarity may be determined using a similarity metric, a function for quantifying the similarity between points (e.g. vectors), objects, or data items by measuring the angle between two points. Calculating proximity values may in some implementations include use of Manhattan distance values or edit distance values.

Referring again to FIG. 5, example calculated values of Euclidean distances and cosine similarities for each vector of the database 522 are shown. For simplicity, let one assume that the input data 602 consisted of 15 data samples, so that the vector database 522 includes 15 embedding vectors V₁ through V₁₅ as shown, each having 10 dimensions as shown. In operation, the input data 602 may consist of many more data samples so that the vector database 522 stores many more vector embeddings (e.g., on the order of millions or billions), and each vector may include many more dimensions, e.g., based on the complexity of the data samples in the input data 602 (though the dimensionality may be reduced depending on the application, as will be appreciated by a person skilled in the art).

For each embedding vector in the set of embedding vectors V₁ through V₁₅, the Euclidean distance between it and another embedding vector in the set may be calculated according to the following formula, where a; and b; are the values of the i-th feature in the vectors a and b, and n is the number of dimensions:

$$D ( a , b ) = \sqrt{{\sum }_{i = 1}^{n} {( {a}_{i} - {b}_{i} )}^{2}}$$

The pairwise Euclidean distance between two embedding vectors is a straight-line distance between the two points the embedding vectors represent in a vector space. For each embedding vector in the set, the pairwise Euclidean distance between it and each other embedding vector in the set may be calculated and then averaged to arrive at an average Euclidean distance for that vector. FIG. 5 illustrates, for example, that the average Euclidean distance for V₁ is 1.004, and the average Euclidean distance for V₁₅ is 1.989. This average Euclidean distance for each vector may serve as a metric to quantify how similar or dissimilar the embedding vector is to others in the set, and therefore how similar or dissimilar the data sample corresponding to the embedding vector is to others in the input data 602. A higher average Euclidean distance indicates higher dissimilarity to others in the set and a lower average Euclidean distance indicates lower dissimilarity to others in the set. The distribution of these average Euclidean distances may also serve as a metric to quantify an overall diversity measure for the set of embedding vectors, with a higher mean of distribution indicating higher diversity. In other words, averaging all of the average Euclidean distances may result in a value that is indicative of the diversity of the set of embedding vectors stored in database 522, and therefore the diversity of the input data set 602. In some implementations, if this calculated value is above a defined threshold value, the input data set 602 may be determined to be satisfactorily diverse.

Similar findings may be made using cosine similarity values. For each embedding vector in the set of embedding vectors V₁ through V₁₅, the cosine similarity between it and another embedding vector in the set may be calculated according to the following formula, where a·b is the dot product of vectors a and b, ∥a∥ and ∥b∥ are, respectively, the magnitude of vector a and vector b:

$${C}_{s} ( a , b ) = \frac{a \cdot b}{‖ a ‖ ‖ b ‖}$$

The cosine similarity calculation may yield a value in the range −1 to 1, with 1 indicating high similarity between vectors a and b and −1 representing low similarity between vectors a and b.

For each embedding vector in the set, the cosine similarity between it and every other embedding vectors in the set may be calculated and averaged to arrive at an average cosine similarity for that vector. FIG. 5 illustrates, for example, that the average cosine similarity for V₁ is 0.403, and the average cosine similarity for V₁₅ is-0.018. This average cosine similarity for each vector may serve as a metric to quantify how similar or dissimilar the embedding vector, and therefore the data sample corresponding to the embedding vector, is to others in the set, with a cosine similarity closer to −1 indicating higher dissimilarity and a cosine similarity closer to 1 indicating lower dissimilarity. The distribution of these average cosine similarity values may also serve as a metric to quantify an overall diversity measure for the set of embedding vectors, where a higher mean of distribution closer to −1 may indicate higher diversity. In other words, averaging all of the average cosine similarity values may result in a value that is indicative of the diversity of the set of embedding vectors stored in database 522, and therefore the diversity of the input data set 602. In some implementations, if this calculated value is less than a defined threshold value between −1 and 1, the input data set 602 may be determined to be satisfactorily diverse.

Other distance or similarity functions may potentially be employed. For example, in some instances, cosine distance values, where cosine distance=1-cosine similarity, may be used. Notably, particular similarity functions may be better suited to use in particular application domains such as, for example, with certain forms of data or when using certain embedding functions, as will be appreciated by a person skilled in the art.

In another example, instead of calculating a distance or similarity metric for all pairs in the vector space, the average distance between an embedding and one or more nearest neighbor embeddings in the embedding space may be computed. The average of such values may provide a measure of the density of the data set, where a lower average distance may indicate a higher concentration of embeddings, at least with respect to the portion of the embedding space corresponding to the embedding and its nearest neighbor embeddings.

Even if the input data 602 is deemed to be sufficiently or satisfactorily diverse using the methods above, it may still include redundant data, thereby leading to issues such as requiring an unnecessarily computationally intensive and long training process. Therefore, the embedding function may be further leveraged to narrow the input data 602 and select a subset of data samples of the input data 602 to form a data set that is simultaneously sufficiently diverse and not redundant (or at least less redundant as compared to input data 602). This resulting data set may be output 606 illustrated in Example A of FIG. 4, which may then be used as a training data set to train a machine learning model. The output 606 may not suffer from redundancy (or may have less redundancy), addressing the issues related to the training process being unnecessarily computationally intensive and long, and may be diverse, addressing the issues leading to a poor performing machine learning model. Sampling the training and evaluations data based on diversity reduces redundancy and allows a small subset of data while ensuring or promoting diversity, allowing for a more efficient and faster training and evaluation iteration.

In one example, the proximity value for each embedding vector obtained using Euclidean distance or cosine similarity functions may be compared to a defined range. If the proximity value of a particular embedding vector falls within the defined range, the data point corresponding to the particular embedding vector may be selected to be included in output 606. For example, with respect to FIG. 5, assume that the range is defined as 1.03 and above in an embodiment where the Euclidean distance function was used. The data samples corresponding to V₃, V₇, V₈, and V₁₅ may then be selected to be included in output 606, while the data samples corresponding to V₁, V₂, V₁₃, and V₁₄ may not be selected to be included in output 606. The data samples corresponding to V₁, V₂, V₁₃, and V₁₄ may instead be discarded. As another example, assume that the range is defined as −1.0 to 0.37 in an embodiment where the cosine similarity function was used. The data samples corresponding to V₂, V₈, and V₁₄ may then be selected to be included in output 606, while the data samples corresponding to V₁, V₃, V₇, and V₁₄ may not be selected to be included in output 606 and instead discarded. In this way, the output 606 may represent a subset of the input data 602 that is diverse and less redundant.

In another example, the embedding vectors may be ranked according to their entropy, where entropy of a particular embedding may be characterized as a measure of the diversity or variability of the particular embedding in relation to other embeddings of the dataset. If using the Euclidean distance function, the embedding with the highest Euclidean distance would be ranked first and the embedding with the lowest Euclidean distance would be ranked last. If using the cosine similarity function, the embedding with the lowest average cosine similarity value would be ranked first, and the embedding with the highest average cosine similarity value would be ranked last. A data cutoff number “x” may be defined, so that the data samples corresponding to the first “x” number of embeddings may be chosen to be included in the output 606. In this way, the most diverse “x” number of data points of the input data 602 can be used to form the output 606. Alternatively, a range “y through z” may be defined so that the data samples corresponding to embeddings that fall within rankings y through z may be chosen to be included in the output 606. The embeddings so chosen may be those with higher entropy.

In another example, instead of using techniques based on computing average pairwise distance or similarity of embedding vectors, other techniques to estimate the density of embeddings corresponding to data points in the embedding space may be employed. For example, a specialized statistical method may be applied to the vector embeddings 604 to estimate the diversity of the vector embeddings 604 (and thereby the input data 602). For example, Kernel Density Estimation (KDE) (sometimes known as Parzen-Rosenblatt window method) may be employed to estimate the probability density function of the embedding vectors 604. Such a method can provide an indication of how data is distributed in the embedding space. Furthermore, regions of high and low concentration of embeddings may be identified. For example, if the resulting KDE curve shows a single tall and sharp peak, this may indicate that embedding vectors are concentrated densely in a particular region and thus the input data 602 may not be sufficiently diverse. If the resulting KDE curve shows multiple smaller peaks or a broadly spread curve, this may indicate that the embedding vectors are more sparsely concentrated in various regions which may in turn indicate that the input data 602 is sufficiently diverse. Other example techniques that may be used include K-means clustering, DBSCAN (density-based spatial clustering of applications with noise), and OPTICS (ordering points to identify the clustering structure).

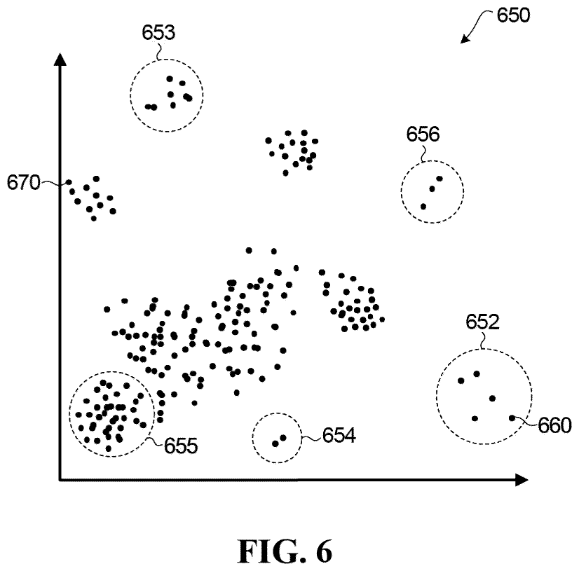

Referring to FIG. 6, a representation of vector embeddings corresponding to data samples of input data 602 in a vector space 650 is illustrated. Each point shown in the vector space may correspond to one data sample. The vector space may be defined by the dimensions and values of the embedding vectors. In FIG. 6, various clusters or regions, such as cluster 652, 653, 654, 655, and 656, may be identifiable, for example by using the aforementioned methods. It may be observed, for example, that some clusters such as cluster 655 are more densely concentrated than others, such as clusters 652 and 654. It may be problematic if all of the data samples were used as training data for training a model, for the reasons described above (e.g., using the data samples corresponding to all of embedding vectors, especially those in dense clusters, may result in an unnecessarily computationally intensive and long training process). It may be beneficial for a subset of the data samples to be chosen as the training data.

To select a subset that is diverse and not (or less) redundant, various iterative methods may be used. For example, low density regions may be identified and embeddings may be selected iteratively, starting from an embedding in a low density region. The training data set can be compiled based on the data points corresponding to the embeddings iteratively selected from the embedding space. In an example, an initial embedding may be selected from a low or lowest density region. In a particular example, cluster 652 may be chosen as a low density region, and point 660 may be selected as the initial embedding forming part of the training data set (i.e., output 606). Then, the data point farthest from data point 660 in the vector space may be chosen as the next embedding selected to form part of the training data set. In FIG. 6, this is illustrated by point 670. Point 670 may be identified using, for example, distance metrics such as Euclidean distance. Subsequent additional embeddings may be selected based on an iterative maximization of a minimum distance (i.e., a minimum distance threshold) between previously selected embeddings and the remaining embeddings. This process may continue until a desired number of embeddings is reached. The desired number of embeddings may then be outputted by computing system 514 as output 606 to be used as a training data set. This training data set may not suffer from the redundancy that at least some portions of the input data 602 did, and at the same time may be sufficiently diverse. Variations on this “greedy” technique or other techniques for selecting embeddings may also or alternatively be employed. For example, the aforementioned iterative technique may be varied by injecting randomness such that rather than strictly maximizing distance, a distance threshold may be employed. In another example, distance may be maximized within some tolerance with values selected from amongst values sufficiently distant using some random function. Conveniently, by injecting some randomness into the process of selecting embeddings, training set generation may be made non-deterministic, thereby potentially allowing more than one diverse training set to be generated from the same overall data set.

In another example, an initial embedding may be selected from amongst the embeddings. Then, for the selected embedding, distances may be computed to some or all of the other embeddings and a furthest embedding from the selected one identified. The distance from the “start” (selected embedding) and “end” (identified furthest embedding from the selected one) can be divided up based on the desired number of samples for the training data set to determine an interval distance. Then starting from the selected embedding, additional embeddings may be identified at incremental steps (multiples of the interval distance) of the interval distance (e.g., such as, for example, based on distance to a previously identified embedding) until the distance from the “start” to the “end” is traversed in steps at which point a final embedding for the training set may be identified from amongst the embeddings. Notably, this final embedding may be the same as the previously identified “end” embedding.

In yet another example, a combination of techniques such as, for example, one or more of the foregoing example techniques including distance metric, similarity metric, and density metric may be employed in order to obtain one or more measures of density of embeddings of sample data points from the data set in the embedding space.

In some implementations, rather than assessing the entire feature space of the embedding vectors at once, diversity can be assessed based on only some of the dimensions. In other words, rather than considering a data set as a whole, diversity may be analyzed by focusing on specific subgroups of features within the data set. Embedding vectors may be constructed for these feature subgroups. By doing so, it may be possible to identify clusters or gaps that may exist within each subgroup. The embeddings can then be used to stratify the data set, allowing segmentation of the data points into meaningful groups based on similarities or differences within the embeddings. The stratification process may allow for a more refined evaluation of diversity within each subgroup. For example, it may highlight areas where diversity might be lacking or where certain patterns are overly dominant, enabling targeted improvements. For example, if the embeddings reveal that certain subsets of data are highly similar or repetitive, those redundant features or examples can be identified and removed.

Example B of FIG. 4 shows an example process where the generative model 540 may be used in addition to the embedding function in embedding model 530.

In some implementations, a dataset may be lacking in data. It may be desirable to generate synthetic data using a generative model. In Example B of FIG. 4, input data 610 is transmitted by the computing system 514 to the generative model 540. The input data 610 may be all or some of the data transmitted to the computing system 514 by client 502. The input data 610 (or a portion thereof) may be fed as part of a prompt to the generative model 540 to serve as a basis for generating synthetic data 612 made up of synthetic data samples. In some implementations, the generative model 540 may be employed as one or more LLMs to generate synthetic data based on seed training examples. For example, a prompt may be supplied to an LLM such as, for example GPT-40, to prompt the LLM to generate synthetic data based on the data samples included in the input data 610. These data samples may be referred to as training examples. In some cases, the generated synthetic data 612 may be entirely different from the training examples, though some overlap between the generated, synthetic data 612 and the training examples may be acceptable so long as there is sufficient volume (i.e., cardinality of the resulting set) and diversity in the resulting set of synthetic data 612 that it may, once further processed (e.g., by filtering as described below), contribute to a training data set of the required diversity and size.

The generative model 540 may transmit the generated synthetic data 612 to the computing system 514, and the computing system 514 transmits the synthetic data 612 to the embedding model 530. In some implementations, the computer system 514 may first assess the diversity of the synthetic data 612 using the methods discussed above. If the synthetic data 612 is deemed to be not satisfactorily diverse, the prompt for the generative model 540 may be modified and the generative model 540 may generate another batch of synthetic data 612. This process may continue until the synthetic data 612 is determined to be satisfactorily diverse.

Using the processes described above, the embedding model 530 converts the synthetic data 612 to a first set of embedding vectors 614 using an embedding function. In some implementations, the generated synthetic data 612 may be as a part of the above-discussed processing. In addition, the computing system 514 may transmit the input data 610, i.e., the training examples, to the embedding model 530, as indicated by arrow 611, and the embedding model 530 may convert the input data 610 to a second set of embedding vectors 616. After the application of the embedding function by the embedding 530 to form embedding vector sets 614 and 616, the embedding model 530 transmits the embedding vector sets 614 and 616 to the computing system 514. The computing system 514 may store the embedding vector sets 614 and 616 in the vector database 522. Referring briefly to FIG. 5, vector database 522 may store the embedding vector sets 614 and 616 in association with the data samples corresponding to each embedding in the embedding vector sets 614 and 616. For example, the data samples of input data 610 may be stored alongside respective embeddings in the first embedding vector set 614, and data samples of the synthetic data 612 may be stored alongside respective embeddings in the second embedding vector set 616 in the database 522 such as, for example, in a table and/or one or more tables such as may, for example, be linked by a key. In some implementations, the data samples of the input data 602 themselves, or some features associated with each of the data samples, may be stored and indexed in the database 522. For example, the database 522 may be indexed/have one or more indexes. Examples of indexing techniques that may be used to create the one or more indexes include inverted index, N-gram index, bag-of-words index, and edge/shape index. Embeddings of the data samples may be computed as needed by applying an embedding function to the stored data samples such as, for example, on demand as embeddings thereof are required/needed.

Referring back to Example B of FIG. 4, the computing system 514 may then perform calculations and determinations based on the first and/or second set of embeddings 614, 616 to produce an output 620.

The above methods discussed in relation to Example A of FIG. 4, of calculating proximity values and/or using techniques for analyzing the density of embeddings to selectively choose embeddings to form an output training data set that is diverse but not (or less) redundant, may generally be implemented for Example B also. In some implementations, the output 620 may include all of the input data 610. In other words, in some implementations it may be assumed that the input data 610 forms part of the output data 620. The output 620 may further include at least a subset of the synthetic data 612. For example, synthetic data samples determined to be not sufficiently distinct/diverse from the input data 610 may be filtered out so that they do not form part of the output data 620, or a subset of the synthetic data 612 that are diverse may be selected and filtered “in” to form part of the output data 620. This may be done by use of a computed proximity value. For example, a synthetic data sample may be considered insufficiently distinct from the input data 610 where one or more distance values calculated between the synthetic data sample and one or more samples of the input data 610 is less than a threshold value. The threshold value may be predefined or may be determined in some manner. For example, the threshold value could be computed based on the input data 602.

In a particular example, using the Euclidean distance function, for each embedding vector in the second set of embeddings 616, the Euclidean distance may be calculated between it and each embedding vector in the first set of embeddings 614 (or at least between it and a portion of embedding vectors in the first set of embeddings 614). The Euclidean distance values may be averaged to arrive at a proximity value for each embedding vector in the second set of embeddings 616 in relation to the first set of embeddings 614. Similarly, in a particular example that uses the cosine similarity function, for each embedding vector in the second set of embeddings 616, the cosine similarity may be calculated between it and each embedding vector in the first set of embeddings 614 (or at least between it and a portion of embedding vectors in the first set of embeddings 614). The cosine similarity values may be averaged to arrive at a proximity value for each embedding vector in the second set of embeddings 616 in relation to the first set of embeddings 614. In another example, edit distance may be used, so that for each embedding vector in the second set of embeddings 616, the edit distance may be calculated between it and each embedding vector in the first set of embeddings 614 (or at least between it and a portion of embedding vectors in the first set of embeddings 614). The proximity value obtained using Euclidean distance or cosine similarity functions or edit distance for each embedding vector in the second set of embeddings 616 may be compared to a defined range. If the proximity value of a particular embedding vector falls within the defined range, the synthetic data sample corresponding to the particular embedding vector may be selected to be included in output 620. If the proximity value of a particular embedding vector falls out of the defined range, the synthetic data sample corresponding to the particular embedding vector may be discarded. In another particular example, the vector embeddings may be ranked according to their entropy. A data cutoff number “x” may be defined, so that the data samples corresponding to the first “x” number of embeddings may be chosen to be included in the output 620. In this way, the most “x” number of data points of the input data 610 can be used to form the output 620. Alternatively, a range “y through z” may be defined so that the data samples corresponding to embeddings that fall within rankings y through z may be chosen to be included in the output 606. The embeddings so chosen may be those with higher entropy. In this way, the computing system 514 may filter out synthetic data that are not sufficiently distinct/diverse from the input data 610. Filtering the synthetic data 612 may also be accomplished by way of a “filtering in” process, whereby a subset of the synthetic data 612 may be constructed by “selecting in” synthetic training examples into a subset by identifying a set of training examples which are sufficiently distinct based on their embeddings.

In some instances, the computing system 514 may use the computed proximity values to determine whether the generated synthetic data is satisfactorily diverse. If determined not to be satisfactory, some or all of the generated synthetic data may be discarded, and regeneration of synthetic data by the generative model 540 may be triggered. This determination may be made, for example, in manners discussed above in the context of filtering, such as by comparing the computed distances to a defined threshold, range, or some other value. For example, if comparisons of the proximity values to a defined range show that the synthetic data is not sufficiently distinct/diverse from the input data 610, new synthetic data may be generated by the generative model 540. This process may be repeated until synthetic data that is sufficiently distinct/diverse from the input data is found. When the synthetic data is found to be not sufficiently distinct/diverse from the input data 610, the prompt given to the generative model 540 may be modified. Additionally or alternatively, entropy employed in output generation by the generative model 540 may be relied on to provide different output on rerunning. In some implementations, entropy may, additionally or alternatively, be adjusted such as, for example, by increasing a temperature parameter of the generative model 540.

In some implementations, the output 620 may include at least a subset of the input data 610 and at least a subset of the synthetic data 612. For example, distance or similarity metrics may be calculated for each of the embeddings in the first set of embeddings 614 also. Proximity values may be calculated for each embedding in the first set of embeddings 614, in relation to every other embedding in the first set of embeddings 614 and/or every embedding in the second set of embeddings 616. The proximity values may be compared to a defined range, so that any embedding in the first set of embeddings 614 that satisfies the defined range may be included as part of output 620 and any embedding in the first set of embeddings 614 that does not satisfy the defined range may be discarded.

As previously discussed, a diverse training set may be more effective in machine learning model training. Accordingly, in some implementations, an embedding function may be used to take an original training set and then augment it with additional elements in order to improve the diversity of the resulting final training data set. Augmenting a training set with additional data points may allow for an improved and better model as compared to one as may have been trained using the training set prior to the augmenting. A better model may, for example, overcome one or more of the above-discussed example deficiencies of a model trained using the original training set. For example, a training data set may consist of images of dogs and cats. The majority of the cat images may be of a single breed—for example, long-furred Persian cats—while other breeds, say Sphinx cats, may be underrepresented. Training a model to recognize dogs and cats using such a training data set may lead to the resulting model struggling to correctly recognize less represented breeds (i.e., breeds less represented in the training set, e.g., breeds other than long-furred Persian cats in our example). This imbalance in the dataset can lead to trained models struggling to correctly classify less represented breeds or variations within a class, as they have not been exposed to sufficient examples during training. Moreover, it may be the case that the long-furred Persian cats in the training set may not be representative of the diversity of long-furred Persian cats. This may mean that the model trained using the set may also struggle to recognize even some long-furred Persian cats. Either of these deficiencies of a model could be considered forms of overfitting. However, whether considered overfitting or not, a root cause of the deficiencies of the model may be traced to a lack of diversity in the training set. Consequently, there is a need for a method to identify highly unique or underrepresented datapoints within a data set and strategically acquire more data similar to those points to enhance the diversity and representativeness of the training dataset. At the root of improving diversity of such a training set may be a need to identify highly unique or underrepresented classes or categories of data points within the training set and/or within a class/classes of data within the training set so that additional data points may be then acquired and added to the training set in order to improve its diversity by remedying or lessening such uniqueness/underrepresentation.

An embedding function may be employed in such cases in order to construct a new, augmented training data set with improved diversity based on the original training data set, with the embedding function guiding the strategic addition of data points to the original training set (i.e., the augmentation of the original training data set with additional data points) in a manner so as to obtain a resulting the new, augmented training set. An embedding function may be used in order to assess uniqueness, or considered another way, the relative difference or similarity of data points within the original training set. Then, data points that are more unique from other data points may be used as a basis for obtaining additional data points which are similar to the more unique data points and that, when added to the training set, have the effect of reducing the uniqueness of those more unique data points. This may have the effect of eliminating or reducing any skew and/or lack of diversity in the original data set.

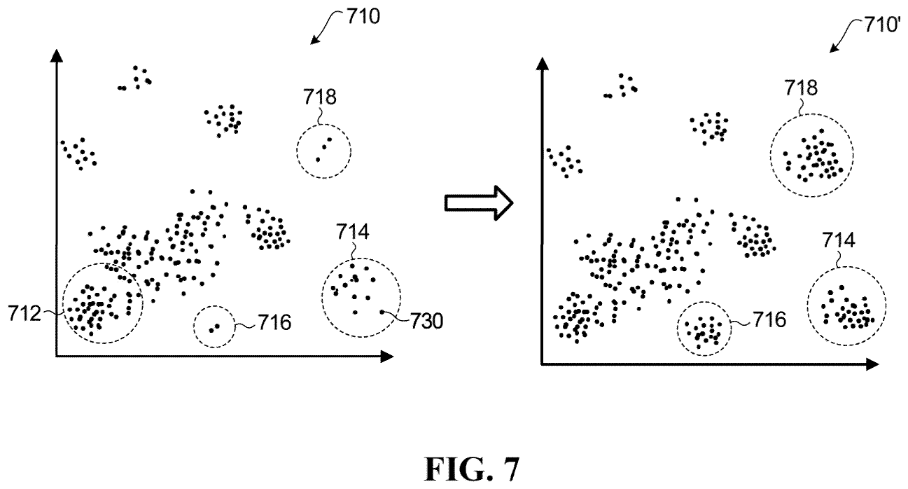

An example method of augmenting a training set using an embedding function to improve its diversity will now be discussed, with reference to FIG. 7 which illustrates a visualization of augmentation of underrepresented portions in a data set using vector embeddings.

First, similar to the process shown in Example A of FIG. 4, the original data set may be transmitted from the client 502 to the computing system 514, and in turn to the embedding model 530. The embedding model 530 may generate embeddings for each of the data points of the original training set. This may be accomplished in manners such as those already discussed above. For example, each data point in a training data set might be embedded by converting it into a dense vector representation using techniques such as convolutional neural networks (CNNs), transformer-based embedding models, or using pre-trained models like ResNet or VGG. (Such embedding methods may similarly be applied in embedding data points for other purposes such as the uses of embedding functions previously discussed above and thus may be considered to be examples of possible embedding models or architecture as might be employed in the construction of training data sets using embedding functions.) Notably, such embeddings may capture the important or even essential features and characteristics of the data points in a high dimensional space. (In some cases, a given such embedding may be of fewer bits than the representation of the data point from which it is derived though this may not be required.) What is captured by an embedding function may in turn facilitate comparison of data points embedded using that embedding function. For example, in FIG. 7, a vector space 710 is illustrated on the left-hand side, the vector space 710 including representations of vector embeddings corresponding to data samples of an original data set. Various clusters or regions, such as 712, 714, 716, and 718 may be identifiable, for example by using methods as described hereinbefore. In some implementations, each cluster may be associated with a respective class.

Then, similarity or dissimilarity may be computed based on the embeddings corresponding to the data points by using methods such as those discussed above, e.g., by applying some similarity or distance metric in order to compare data points. For example, similarity may be calculated pairwise by determining e.g., Euclidean distance, cosine similarity, or Manhattan distance between all pairs of embeddings in the data set or, potentially, between pairs of embeddings within a given class (the latter being possible, for example, where the data points are labeled as to their classes), and then averaging these similarity values to calculate a proximity value or average similarity score. In some implementations, an average similarity score may serve as a metric to quantify how similar or dissimilar a data sample is to others in its class. In this way, outlier or unique data points may be identified. For example, data points of the original training set, or data points within a given class of data points in the original training set, having the lowest average similarity score(s) (e.g., compared to the rest of the data set or the rest of the data points of that class) may be identified as being unique or outliers. Notably, such unique values may be considered to be representative of types of data underrepresented within a class or the data set, as the case may be, i.e., depending on what metrics were being compared/how the proximity value or average similarity score was computed. The data samples corresponding to embeddings with the lowest proximity values or average similarity scores may be selected as the most unique or underrepresented examples within the class. These data samples may be referred to as “seed” samples. For example, with reference to FIG. 7, it may be observable that data samples corresponding to embeddings represented in clusters 714, 716, and 718 are more sparse than other clusters, such as cluster 712. It may be determined that data samples corresponding to embeddings represented in clusters 714, 716, and 718 may have lower proximity values than others in the original data set, such as those of cluster 712. Alternatively or additionally, it may be determined that within a sparser cluster, there are one or more embeddings with lower average similarity scores than other embeddings in the same class, such as data point 730 in cluster 714.

The seed samples may then be used in order to identify additional data points similar to them (e.g., from within a larger overall data set or some other data source (e.g., the web) in order to find additional data points that are similar to such seed samples. For example, the seed samples may be used to query a larger data set or data source to find data samples that are similar to the seed samples. This can be achieved by computing vector similarities, e.g., applying similarity or distance metrics, between the embeddings of the seed samples and the embeddings of samples in the larger dataset. Data samples from the larger data set with high or satisfactory proximity values to the seed samples (e.g., those with a proximity value that satisfies a threshold value or range of values) may be identified as potential candidates for inclusion in the final training dataset. For example, the cosine similarity function may be used to calculate, for each embedding of the samples in the larger data set, a cosine similarity between it and each embedding of the seed samples. A particular sample of the larger data set may be selected to be included in the final training data set if the cosine similarity between it and an embedding of a seed sample is within a defined range. In another example, edit distance may be used. For each embedding of the samples in the larger data set, edit distances between it and each embedding of the seed samples may be calculated. A particular sample of the larger data set may be selected to be included in the final training data set if the edit distance between it and an embedding of a seed sample is within a defined range. The original data set may then be augmented with some or all of these additional data points corresponding to data samples with high similarity scores, to form the final training data set. For example, vector space 710′ shown in FIG. 7 illustrates a visualization where the original data set has been augmented. It can be seen that clusters 714, 716, and 718 are now more densely populated, with the addition of points corresponding to the newly added data samples from the larger data set.

The newly sourced data samples may increase the diversity and representativeness of the underrepresented variations within the classes of the original data set. Conveniently, in this way the diversity of the original training data set may be increased also. Additionally or alternatively, representation of identified underrepresented sorts of data may be enhanced. By employing this embedding similarity-based approach, the original training dataset can be strategically augmented with datapoints that are similar to the most unique or underrepresented examples within the data set or one or more classes within the data set. In this way, a training set is improved so that a model trained using it may be exposed to a more diverse range of variations during training as compared to a model trained using the unaugmented training set. Conveniently, this may have the salutary effect of leading to improved generalization of the model and/or reduced misclassification (e.g., of less common instances) when the model is used for classification.

Although it was noted above that a data set that may have its diversity improved by augmentation (e.g., such as in manners discussed above) may, when used to train a machine learning model, result in a better model as compared to a model trained using the original unaugmented training set, it will be appreciated that such techniques may be employed in order to improve a training set without having first used the original, unaugmented training set to train a model. Put another way, embedding functions may be employed to estimate the coverage or diversity of a training set before the training set is used to train a model. Notably, this may allow a better model to be trained without having to first train a model using the original training set, evaluate that trained model, and then determine it is not of sufficient quality such that its training set may require improvement. Conveniently, this may allow the processing or consumption of computing resources in the training of a model that will be found unacceptable (implying its training set may require improvement) to be avoided. The embeddings and distances to the embeddings can be used to estimate the coverage of the training set before training a machine-learning model. The alternative, i.e., training with an original data set and then evaluating the model before employing these methods requires much more compute resources.

Moreover, this technique can be applied not only prior to model training but also in scenarios where a trained model is already in production. In real-world applications, data distributions may shift over time, with new styles, attributes, or variations of objects emerging. When the deployed model encounters datapoints that are representative of these recent trends and exhibits low confidence in its predictions, the systems and methods disclosed herein can be utilized to identify those data points as seeds for gathering additional training data. By retraining the model with the augmented dataset, its performance on the evolving data distribution can be improved, ensuring its continued effectiveness in production environments.

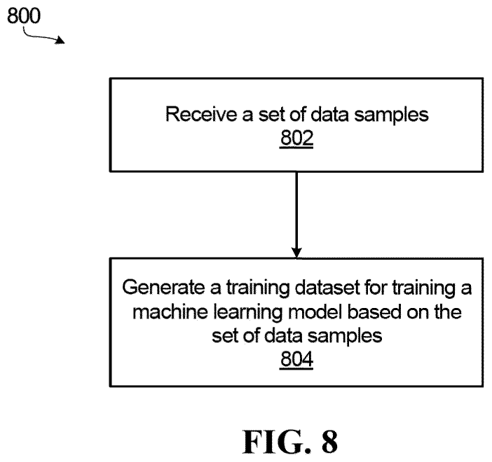

FIG. 8 illustrates a computer-implemented method for assessing and controlling the diversity of data, according to some implementations. The method may be implemented by a system

At step 802, the processor 516 of the computing system 514 may receive a set of data samples. These data samples may be provided by client 502.

At step 804, the processor 516 may generate a training data set for training a machine learning model based on the set of data samples. The generation of the training data set may employ an embedding function for controlling a diversity of the training data set.

In some implementations, the generation of the training data set may include using the embedding function to convert at least some of the data samples into a set of embeddings. Each embedding in the set of embeddings may correspond to a respective data sample in the set of data samples. For example, an embedding model such as embedding model 530 may utilize the embedding function to convert at least some of the data samples into the set of embeddings. The embedding function or embedding model employed may be selected from amongst known embedding functions or embedding models or may be constructed to be particularly applicable to certain forms of data. Notably, certain embedding functions or embedding models may be better suited than other embedding functions or embedding models to particular applications or scenarios. For example, some well-known embedding functions or embedding models are constructed for use in certain domains and thus may be particularly applicable in the construction of data sets in the same or related domains, as will be appreciated by a person skilled in the art. Examples of the embedding model 530 that may be used include Word2Vec™, GloVe™, BERT™, ResNet™, VGG™, and CLIP™.

The generation of the training data set may further include determining proximity values using the set of embeddings, and selecting samples for the training data set based on the determined proximity values. As discussed previously, a proximity value may be indicative of proximity or similarity of an embedding to one or more other of the embeddings. In some implementations, determining proximity values in the set of embeddings may include computing a plurality of values, each value computed using the embedding and a respective different embedding by evaluating a distance metric or a similarity metric using the embedding and the respective different embedding. The average of the plurality of values may be determined, and the proximity value may be determined from the average. X

For example, in some implementations, determining a proximity value may include determining Euclidean distance values or cosine distance values between pairs of embeddings in the set of embeddings. Determining a proximity value using Euclidean distances between pairs of embeddings was discussed hereinbefore in relation to FIGS. 4 and 5. In a particular example, pairwise Euclidean distances between a particular embedding and every other embedding in the set of embeddings may be computed. This may then be averaged to arrive at a proximity value for that particular embedding. As another example, determining a proximity value may include determining cosine similarity between pairs of embeddings in the set of embeddings, such that the plurality of values is a plurality of cosine similarity values, wherein the similarity metric is cosine similarity, and wherein each cosine similarity value is computed using the embedding and the respective different embedding by evaluating the cosine similarity of the embedding and the respective different embedding. Determining a proximity value using cosine similarities between pairs of embeddings was discussed hereinbefore in relation to FIGS. 4 and 5. In a particular example, pairwise cosine similarities between a particular embedding and every other embedding in the set of embeddings may be computed. This may then be averaged to arrive at a proximity value for that particular embedding.

In some implementations, each computed proximity value may be compared to a defined range. Based on this comparison, a portion of the embeddings may be selected with each embedding in the portion having a corresponding proximity value within the defined range. For example, in relation to embedding vectors V₁ through V₁₅ in FIG. 5 it was discussed that once proximity values have been computed, the proximity value of each embedding vector may be compared to a defined range. For example, in the example where Euclidean distance values were used to compute the proximity value, an example range may be defined as 1.03 and above. In this case, data samples corresponding to V₃, V₇, V₈, and V₁₅ may be included in the selected portion as they fall in the defined range, while data samples corresponding to V₁, V₂, V₁₃, and V₁₄ may not be selected as they fall out of the defined range. In some cases, the range may be defined based on the proximity values obtained for that specific set of embeddings. Alternatively, the defined range may be fixed regardless of the set of embeddings being considered. In some implementations, the training data set may be formed as the data samples that correspond to the selected portion of the set of embeddings.

In some implementations, selecting the portion of embeddings includes assigning a ranking to each respective determined proximity value, establishing the defined range based on the assigned rankings, and selecting the portion of embeddings whose respective rankings are within the defined range. For example, as discussed in relation to FIGS. 4 and 5, embedding vectors may be ranked according to their entropy, where entropy of a particular embedding may be characterized as a measure of the diversity or variability of the particular embedding in relation to other embeddings of the set of data samples. If using the Euclidean distance function, for example, the embedding with the highest Euclidean distance may be ranked first and the embedding with the lowest Euclidean distance may be ranked last. If using the cosine similarity function, for example, the embedding with the lowest average cosine similarity value may be ranked first, and the embedding with the highest average cosine similarity value may be ranked last. A data cutoff number “x” or a range “y through z”, so that the data samples corresponding to the first “x” number of embeddings or the data samples corresponding to embeddings that fall within rankings y through z may be selected to be included in the portion.

In some implementations, the set of data samples may be a first set of data samples and generation of the training data set may include inputting at least one of the first set of data samples into a generative model that utilizes machine learning to generate a second set of data samples. For example, as discussed above, processor 516 of the computing system 514 may provide at least some of the received data from the client to the generative model 540, such as a large language model. The computing system 514 may then receive, from the generative model 540, synthetic training data generated by the generative model 540. Generation of the training data set may further include using the embedding function to convert at least some of the first set of data samples and at least some of the second set of data samples into a first set of embeddings and second set of embeddings. Each embedding in the first set of embeddings may correspond to a respective data sample in the first set of data samples and each embedding in the second set of embeddings may correspond to a respective data sample in the second set of data samples. For example, as described in relation to Example B of FIG. 4, data received from the client 502 may be the first set of data samples, and input data 610 may represent at least some of the first set of data samples that are fed to the generative model 540. Generative model 540 may generate a second set of data samples, i.e., synthetic data 612. At least some of the input data 610 and the synthetic data 612 may be transmitted to the embedding model 530, which returns a first set of embeddings 614 and a second set of embeddings 616, with the first set of embeddings corresponding to respective data samples in the input data 610 and the second set of embeddings corresponding to respective data samples in the synthetic data 612.

In some implementations, the output 620 may include all of the input data 610 and at least a subset of the synthetic data 612. In other words, it may be assumed that the input data 610 forms part of the output data 620. Generation of the training data may then further include, for each of one or more embeddings in the second set of embeddings, determining a proximity value using at least one embedding from the first set of embeddings, comparing the proximity value to a defined range, and if the proximity value is within the defined range, selecting the respective data sample in the second set of data sample corresponding to the embedding to be included in the training data set. For example, as described above, a proximity value may be determined for each embedding in the second set of embeddings 616 by using a distance metric or similarity metric. In a particular example, using the Euclidean distance function, the Euclidean distance may be calculated between for a particular embedding vector in the second set of embeddings 616 and every other embedding vector in the first set of embeddings 614 (or at least a portion thereof). The Euclidean distance values may then be averaged to arrive at a proximity value for the particular embedding vector in the second set of embeddings 616 in relation to the first set of embeddings 614. The output 620 may be the training data set. In another particular example, using the cosine similarity function, the Euclidean distance may be calculated between for a particular embedding vector in the second set of embeddings 616 and every other embedding vector in the first set of embeddings 614 (or at least a portion thereof). The cosine similarity values may then be averaged to arrive at a proximity value for the particular embedding vector in the second set of embeddings 616 in relation to the first set of embeddings 614. The proximity value obtained may be compared to a defined range. If the proximity value of a particular embedding vector falls within the defined range, the synthetic data sample corresponding to the particular embedding vector may be selected to be included in output 620.

In other implementations, the output may include output 620 may include at least a subset of the input data 610 and at least a subset of the synthetic data 612. Generation of the training data may then further include determining a proximity value for each embedding in the first set of embeddings as well as the second set of embeddings. Generation of the training data may further include selecting a portion of embeddings from the first and second sets of embeddings, wherein each embedding included in the portion of embeddings has a corresponding proximity value within a defined range. For example, distance or similarity metrics may be calculated for each of the embeddings in the first set of embeddings 614 also, such that proximity values are calculated for each embedding in the first set of embeddings 614, in relation to every other embedding in the first set of embeddings 614 and/or every embedding in the second set of embeddings 616. The proximity values may be compared to a defined range, so that any embedding in the first set of embeddings 614 that satisfies the defined range may be included as part of output 620 and any embedding in the first set of embeddings 614 that does not satisfy the defined range may be discarded, similar to the process implemented for the second set of embeddings 616. Data points (e.g., from the input data 610 or synthetic data 612) that correspond to embeddings from the first and second sets of embeddings 614, 616 that satisfy the defined range may be used to form the training data set.

In some implementations, an embedding function may be employed to augment an original data set. For example, the plurality of data samples may form an original training data set, and generation of the training data may include assessing the diversity of the original training data set using an embedding function, where the assessing includes using the embedding function to identify data points of the original training data set representative of underrepresented classes of data. As described above in relation to FIG. 7, for example, an embedding function may be used to identify regions within the dataset that are representative of underrepresented classes of data. In a particular example, data samples in the underrepresented classes of data may be used to query a larger data set, such as by determining similarity between embedding vectors corresponding to these data samples and embedding vectors corresponding to data samples of the larger data set. The generation of the training data may further include obtaining additional data samples that are similar to the data samples in the underrepresented classes of data, and augmenting the original training data set with the additional data samples, with the augmenting yielding the training data set.

### CONCLUSION

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Example embodiments of the present application are not limited to any particular operating system, system architecture, mobile device architecture, server architecture, or computer programming language. As noted, certain adaptations and modifications of the described embodiments can be made. Therefore, the above discussed embodiments are considered to be illustrative and not restrictive.

The scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc

Any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

Memory, as used herein, may refer to memory that is persistent (e.g. read-only-memory (ROM) or a disk), or memory that is volatile (e.g. random access memory (RAM)). The memory may be distributed, e.g. a same memory may be distributed over one or more servers or locations.

1. A computer-implemented method comprising:
receiving a set of data samples, and
generating a training data set for training a machine learning model based on the set of data samples, wherein the generation employs an embedding function for controlling a diversity of the training data set.

2. The computer-implemented method of claim 1, wherein generating the training data set comprises:
using the embedding function to convert at least some of the data samples into a set of embeddings, each embedding in the set of embeddings corresponding to a respective data sample in the set of data samples;
determining proximity values using the set of embeddings, wherein a proximity value is indicative of proximity of an embedding to one or more other of the embeddings; and
selecting samples for the training data set based on the determined proximity values.

3. The computer-implemented method of claim 2, wherein determining proximity values comprises determining Euclidean distances between pairs of embeddings in the set of embeddings.

4. The computer-implemented method of claim 2, wherein determining proximity values comprises determining cosine similarities between pairs of embeddings in the set of embeddings.

5. The computer-implemented method of claim 1, wherein generating the training data set comprises:
using the embedding function to convert at least some of the data samples into a set of embeddings, each embedding in the set of embeddings corresponding to a respective data sample in the set of data samples;
determining a proximity value for each of one or more embeddings in the set of embeddings, the proximity value being indicative of proximity of an embedding to one or more other of the embeddings;
comparing each proximity value to a defined range;
selecting a portion of embeddings based on the comparison, wherein each embedding included in the portion has a corresponding proximity value within the defined range; and
forming the training data set as the data samples that correspond to the selected portion of the set of embeddings.

6. The computer-implemented method of claim 5, wherein determining the proximity value for an embedding in the set of embeddings comprises:
computing a plurality of values, each value computed using the embedding and a respective different embedding by evaluating a distance metric or a similarity metric using the embedding and the respective different embedding;
determining an average of the plurality of values; and
determining the proximity value from the average of the plurality of values.

7. The computer-implemented method of claim 6, wherein the plurality of values is a plurality of cosine similarity values, wherein the similarity metric is cosine similarity, and wherein each cosine similarity value is computed using the embedding and the respective different embedding by evaluating the cosine similarity of the embedding and the respective different embedding.

8. The computer-implemented method of claim 6, wherein selecting the portion of embeddings comprises:
assigning a ranking to each respective determined proximity value;
establishing the defined range based on the assigned rankings; and
selecting the portion of embeddings whose respective rankings are within the defined range.

9. The computer-implemented method of claim 1, wherein the set of data samples is a first set of data samples, and wherein generating the training data set comprises:
inputting at least one of the first set of data samples into a generative model that utilizes machine learning to generate a second set of data samples;
using the embedding function to convert at least some of the first set of data samples and at least some of the second set of data samples into a first set of embeddings and second set of embeddings, each embedding in the first set of embeddings corresponding to a respective data sample in the first set of data samples and each embedding in the second set of embeddings corresponding to a respective data sample in the second set of data samples;
for each of one or more embeddings in the second set of embeddings:
determining a proximity value using at least one embedding from the first set of embeddings, the proximity value being indicative of proximity of an embedding to one or more other of the embeddings;
comparing the proximity value to a defined range; and
if the proximity value is within the defined range, selecting the respective data sample in the second set of data sample corresponding to the embedding to be included in the training data set.

10. The computer-implemented method of claim 9, wherein determining the proximity value for an embedding in the second set of embeddings comprises:
evaluating a distance metric or a similarity metric using the embedding and an embedding from the first set of embeddings.

11. The computer-implemented method of claim 10, wherein the distance metric is Euclidean distance, and determining the proximity value comprises evaluating the Euclidean distance between the embedding and an embedding from the first set of embeddings.

12. The computer-implemented method of claim 9, wherein the training data set further includes the first set of data samples.

13. The computer-implemented method of claim 1, wherein the set of data samples is a first set of data samples, and wherein generating the training data set comprises:
inputting the first set of data samples into a generative model that utilizes machine learning to generate a second set of data samples;
using the embedding function to convert at least some of the first set of data samples and at least some of the second set of data sample into a first set of embeddings and a second set of embeddings, each embedding in the first set of embeddings corresponding to a respective data sample in the first set of data samples and each embedding in the second set of embeddings corresponding to a respective data sample in the second set of data samples;
determining a proximity value for each embedding in the first set of embeddings and the second set of embeddings, the proximity value being indicative of proximity of an embedding to one or more other of the embeddings;
selecting a portion of embeddings from the first and second sets of embeddings, wherein each embedding included in the portion of embeddings has a corresponding proximity value within a defined range; and
forming the training data set as the data samples that correspond to the selected portion of embeddings.

14. A computer system comprising:
at least one processor; and
a memory storing processor-executable instructions that, when executed, cause the at least one processor to:
receive a set of data samples, and
generate a training data set for training a machine learning model based on the set of data samples, wherein the generation employs an embedding function for controlling a diversity of the training data set.

15. The system of claim 14, wherein the processor is to generate the training data set by performing operations including:
using the embedding function to convert at least some of the data samples into a set of embeddings, each embedding in the set of embeddings corresponding to a respective data sample in the set of data samples;
determining proximity values using the set of embeddings, wherein a proximity value is indicative of proximity of an embedding to one or more other of the embeddings; and
selecting samples for the training data set based on the determined proximity values.

16. The system of claim 14, wherein the processor is to generate the training data set by performing operations including:
using the embedding function to convert at least some of the data samples into a set of embeddings, each embedding in the set of embeddings corresponding to a respective data sample in the set of data samples;
determining a proximity value for each of one or more embeddings in the set of embeddings, the proximity value being indicative of proximity of an embedding to one or more other of the embeddings;
comparing each proximity value to a defined range;
selecting a portion of embeddings based on the comparison, wherein each embedding included in the portion has a corresponding proximity value within the defined range; and
forming the training set as the data samples that correspond to the selected portion of the set of embeddings.

17. The system of claim 16, wherein the processor is to determine the proximity value for an embedding in the set of embeddings by performing operations including:
computing a plurality of values, each value computed using the embedding and a respective different embedding by evaluating a distance metric or a similarity metric using the embedding and the respective different embedding;
determining an average of the plurality of values; and
determining the proximity value from the average of the plurality of values.

18. The system of claim 14, wherein the set of data samples is a first set of data samples, and wherein the processor is to generate the training data set by performing operations including:
inputting at least one of the first set of data samples into a generative model that utilizes machine learning to generate a second set of data samples;
using the embedding function to convert at least some of the first set of data samples and at least some of the second set of data samples into a first set of embeddings and second set of embeddings, each embedding in the first set of embeddings corresponding to a respective data sample in the first set of data samples and each embedding in the second set of embeddings corresponding to a respective data sample in the second set of data samples;
for each of one or more embeddings in the second set of embeddings:
determining a proximity value using at least one embedding from the first set of embeddings, the proximity value being indicative of proximity of an embedding to one or more other of the embeddings;
comparing the proximity value to a defined range; and
if the proximity value is within the defined range, selecting the respective data sample in the second set of data sample corresponding to the embedding to be included in the training data set.

19. The system of claim 14, wherein the set of data samples is a first set of data samples, and wherein the processor is to generate the training data set by performing operations including:
inputting the first set of data samples into a generative model that utilizes machine learning to generate a second set of data samples;
using the embedding function to convert at least some of the first set of data samples and at least some of the second set of data sample into a first set of embeddings and a second set of embeddings, each embedding in the first set of embeddings corresponding to a respective data sample in the first set of data samples and each embedding in the second set of embeddings corresponding to a respective data sample in the second set of data samples;
determining a proximity value for each embedding in the first set of embeddings and the second set of embeddings, the proximity value being indicative of proximity of an embedding to one or more other of the embeddings;
selecting a portion of embeddings from the first and second sets of embeddings, wherein each embedding included in the portion of embeddings has a corresponding proximity value within a defined range; and
forming the training set as the data samples that correspond to the selected portion of embeddings.

20. A non-transitory computer readable medium having stored thereon computer-executable instructions that, when executed by a computer, cause the computer to perform operations comprising:
receiving a set of data samples,
generating a training data set for training a machine learning model based on the set of data samples, wherein the generation employs an embedding function for controlling a diversity of the training data set.
